(19) United States
(12) Patent Application Publication
(10) Pub. No.: US 2007/0076667 A1
(43) Pub. Date: Apr. 5, 2007

(54) Apparatus, method and computer program product to provide Flow_ID management in MAC sub-layer for packet-optimized radio link layer

(75) Inventors: Tsuyoshi Kashima, Kanagawaken (JP); Kimmo Kettunen, Espoo (FI); Mikko J. Rinne, Espoo (FI); Vinh Van Phan, Oulu (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/543,439

(22) Filed: Oct. 3, 2006

Related U.S. Application Data
(60) Provisional application No. 60/723,774, filed on Oct. 4, 2005.
(60) Provisional application No. 60/756,929, filed on Jan. 5, 2006.

(51) Int. Cl. H04B 7/216

(52) U.S. Cl. 370/335; 370/469

(57) ABSTRACT

A series of logical channel identifiers LCIDs, each associated with one radio link service profile RLSP, is stored in a local memory. The local memory is accessed whenever a LCID is taken into use for identifying an active logical channel, and each RLSP includes a set of radio link service parameters at least one of which is a quality of service parameter. A first data packet bearing a LCID and establishing a flow is received over a wireless logical channel. The local memory is accessed to determine if an RLSP is associated with the LCID of the first data packet. For the case where an RLSP is not associated with the LCID in the local memory, the LCID is associated with a designated default RLSP, and the first data packet is processed using the designated default RLSP. Predetermined and custom RLSPs are also described, as are methods, devices, programs, an integrated circuits embodying the invention.

### CROSS-REFERENCE TO A RELATED U.S. PROVISIONAL PATENT APPLICATION

This application claims priority to Provisional U.S. Patent Application No. 60/723,774, filed on Oct. 4, 2005; and also to Provisional US Patent Application No. 60/756,929, filed on Jan. 5, 2006, the contents of both being hereby incorporated by reference in their entirety. This application is further related to commonly assigned U.S. patent application Ser. No. 11/509,502, filed Aug. 23, 2006, entitled “Apparatus, Method and Computer Program Product to Configure a Radio Link Protocol for Internet Protocol Flow”, by Mika P. Rinne and Jean-Philippe Kermoal, also incorporated by reference herein in its entirety.

### TECHNICAL FIELD

The exemplary and non-limiting embodiments of this invention relate generally to wireless communications systems, methods, device and computer program products and, more specifically, relate to the use of a wireless link between two system elements.

### ABBREVIATIONS

The following abbreviations are defined as follows:
3GPP: Third Generation Partnership Project
RAN Radio Access Network
UTRAN: Universal Terrestrial Radio Access Network
E-UTRAN: Evolved UTRAN (3.9G)
UE: User Equipment (3G and evolved 3G terminal)
BS: Base Station
DL Downlink, BS to UE
UL Uplink, UE to BS
IPCS: IP Convergence Sub-layer
RRC: Radio Resource Control
SDU: Service Data Unit (a higher layer Protocol Unit, e.g. a single IP packet)
MAC: Medium Access Control protocol
MAC-d: MAC entity handling dedicated channels in UTRAN
MAC-u/c: MAC-(user/control plane)
C/T: Traffic/Control in MAD-d PDU header
TCTF: Traffic Channel Type Field in MAC-d PDU header
SAP: Service Access Point (a local protocol interface)
PDU: Protocol Data Unit (protocol unit of the active layer)
PHY: Physical Layer
DCCH: Dedicated Control Channel (a logical channel type)
DTCH: Dedicated Traffic Channel (a logical channel type)
CTCH: Common Traffic Channel (a logical channel type)
MTCH: Multimedia Traffic Channel (a logical channel type)
MBMS Multimedia Broadcast Multicast Simulcast
IP: Internet Protocol
VoIP: Voice over IP
TCP: Transmission Control Protocol (above IP)
UDP: User Datagram Protocol (above IP)
DSCP: Differentiated Services Code Point (a code given for a differentiated service flow in a network node)
DiffServ: Differentiated service (service flow differentiation present in a field of every IP packet)
TFID: Traffic Flow Identity (TFID) is a unique identifier of an upper layer packet flow at the IPCS-u. TFID is a defined combination of IP Source Address, IP Destination Address, Source Port, Destination Port and DiffServ field (and possibly other attributes). TFID is given by IPCS.
RLID: Radio Link Identity (RLID) is a unique identity of the radio link of a UE in a given cell. RLID is given by RRC. RLID changes, when serving cell is changing.
RLSP: Radio Link Service Profile. In accordance with the exemplary embodiments of the invention described in commonly assigned U.S. patent application Ser. No. 11/509,502, a RLSP is defined for an upper layer flow by the RRC. The RLSP contains a unique profile identity per UE with a set of quality and transport parameters. These quality and transport parameters are to be satisfied over the MAC-u SAP peer entities. The RLSP replaces the UTRAN radio bearer concept in order to satisfy the C-plane and U-plane low latency requirements set for E-UTRAN. The RLSP may be considered to be a profile containing QoS attributes
RLSP identity: a unique reference number for a RLSP
LCID: Logical Channel (Flow) identity allows a logical channel to be divided into one or more logical channel flows. Each logical channel flow is uniquely identified by the LCID.
GERAN: GSM/EDGE Radio Access Network
UMTS: Universal Mobile Telephone System

### BACKGROUND

In the conventional UTRAN/GERAN system implementations the concept of a radio bearer is needed to setup a connection between the RNC and the LE. However, the radio bearer configuration process requires considerable signaling to negotiate the transport quality and bearer parameters. In practice, the bearer structure is hierarchical between several network entities since the UMTS bearer, radio access bearer and transport bearers (i.e. Iu bearer) are needed, in addition to the radio bearers to carry a flow over the RAN.

This type of bearer structure adds delay in the flow set-up, and is difficult to update or reconfigure dynamically.

As it is expected that wireless IP traffic will become even more dominant in the future, new requirements for set-up delay, bit rates and dynamic adjustability will be needed for radio access technologies. However, the current radio bearer concept will not meet these requirements the most efficiently.

It can be noted that an attempt has been made to enhance the bearer concept to become more packet oriented and flexible, as described in 3GPP 25.331, version 6.x. Further, some newer radio systems, other than 3G UTRAN/GERAN, have means to operate without bearers, because of their Ad Hoc networking nature and the use of random access channel reservations.

The latency caused by radio bearer setups (as seen in UTRAN) can be mitigated by the use of pre-defined RLSPs (such as “default RLSP” and “pre-configured RLSP”) as defined in accordance with the exemplary embodiments of the invention described in the commonly assigned U.S. patent application Ser. No. 11/509,502 (hereinafter, the incorporated application).

The basic principle is described in an International Application filed 15.07.2004, entitled “In-Band Set-Up and Configuration of Transfer-Related Resources” by Mikko Rinne and Carl Eklund. The invention described in this International Application covers the aspect of creating an identifier for an entity in a first network node and sending it to a second network node for setting up a second entity to process data marked by the identifier (the principle of unregistered FlowID). This International Application also describes having default parameters for the entity in the second network node, configuration of the entity based on either inband signaling or by later configuration through explicit signaling, and removal of the entity based on inactivity.

In accordance with the exemplary embodiments of the invention described in the incorporated application there are described the creation of a RLSP, an assignment of a RLSP to an IP flow, and signaling to invoke or to create a RLSP peer-to-peer and the usage of the RLSP in the IP flow in the context of MAC SDU delivery. The RLSP can be one of a default RLSP, a pre-configured RLSP, or a customized RLSP.

### SUMMARY

In accordance with an embodiment of the invention is a method wherein a series of logical channel identifiers LCIDs, each associated with one RLSP, are stored in a local memory. Each RLSP includes a set of radio link service parameters, at least one of which is a quality of service parameter. The local memory is accessed whenever an LCID is taken into use for identifying an active logical channel. After storing, a first data packet bearing a LCID that establishes a flow is received over a wireless logical channel. The local memory is then accessed to determine if an RLSP is associated with the LCID. For the case where an RLSP is not associated with the LCID in the local memory, the LCID is associated with a designated default RLSP. Then, the first data packet is processed using the designated default RLSP. In an example, processing the data packet with the designated default RLSP includes forwarding the packet to another node using the RLSP set of parameters.

In accordance with another aspect of the invention is provided a method for operating a user equipment UE. The method includes storing in a local memory a series of logical channel identifiers LCIDs each associated with one radio link service profile RLSP, said local memory accessed whenever a LCID is taken into use for identifying an active logical channel, and each RLSP comprising a set of radio link service parameters at least one of which is a quality of service parameter. The method determines from a received message a maximum number of unregistered logical uplink channels. At least one flow is established using an unregistered LCID that is not associated in the local memory with an RLSP, and a data packet is prepared to be sent on an additional flow using an additional unregistered LCID. The maximum number is then compared to the total number of logical uplink channels in use by the UE on flows using an unregistered LCID. Responsive to the comparing and for the case where the total number exceeds the maximum number, then the UE acts to reduce the total number of logical uplink channels in use.

In accordance with another aspect of the invention is provided a program of machine-readable instructions, tangibly embodied on an computer readable memory and executable by a digital data processor, to perform actions directed toward processing a data packet with a set of service parameters. The actions include storing in a local memory a series of logical channel identifiers LCIDs each associated with one radio link service profile RLSP, where the local memory is accessed whenever a LCID is taken into use for identifying an active logical channel, and each RLSP comprising a set of radio link service parameters at least one of which is a quality of service parameter. After storing, it is determined from a first data packet received over a wireless logical channel a LCID that establishes a flow. The local memory is accessed to determine if an RLSP is associated with the LCID. For the case where an RLSP is not associated with the LCID in the local memory, then the LCID is associated with a designated default RLSP, and the first data packet is processed using the designated default RLSP.

In accordance with another aspect of the invention is provided a device that includes a memory, a transceiver, and a processor. The memory stores executable software for the processor, and also a series of logical channel identifiers LCIDs each associated with one radio link service profile RLSP, where the memory is accessed whenever a LCID is taken into use for identifying an active logical channel, and where each RLSP comprises a set of radio link service parameters at least one of which is a quality of service parameter. The transceiver operates to receive over a wireless logical channel a first data packet bearing a LCID that establishes a flow. The processor is coupled to the memory and the transceiver and operates to determine if there is an association in the memory of an RLSP with the LCID. For the case where an RLSP is not associated with the LCID in the memory, the processor further operates to associate the LCID with a designated default RLSP, and to process the first data packet using the designated default RLSP.

In accordance with another aspect of the invention is provided a user equipment such as a mobile station. The user equipment includes a memory, a transceiver, and a processor. The memory is to store a series of logical channel identifiers LCIDs each associated with one radio link service profile RLSP, and is accessed whenever a LCID is taken into use of identifying an active logical channel. Each RLSP includes a set of radio link service parameters at least one of which is a quality of service parameter. The transceiver is to wirelessly receive a message indicating a maximum number of unregistered logical uplink channels, and to establish at least one flow using an unregistered LCID that is not associated in the local memory with an RLSP. The processor is for preparing a data packet to be sent on an additional flow using an additional unregistered LCID, and the processor further operates to compare the maximum number to the total number of logical uplink channels in use by the UE on flows using an unregistered LCID, an responsive to the comparing. For the case where the total number exceeds the maximum number, the processor operates to reduce the total number of logical uplink channels in use.

In accordance with another aspect of the invention is provided an integrated circuit that includes various circuitry that is functionally described as: 1) circuitry to determine from a first data packet received over a wireless logical channel a LCID that establishes a flow; 2) circuitry to determine, from a local memory coupled to the integrated circuit, whether the memory stores a series of logical channel identifiers LCIDs each of which is associated with one radio link service profile RLSP, whether the LCID of the first data packet is associated with an RLSP. The local memory is accessed whenever a LCID is taken into use of identifying an active logical channel. Each RLSP includes a set of radio link service parameters at least one of which is a quality of service parameter. Further, the integrated circuit has 3) circuitry for associating the LCID with a designated default RLSP for the case where an RLSP is not already associated with the LCID in the local memory; and 4) circuitry for processing the first data packet using the designated default RLSP.

In accordance with another aspect of the invention is provided a device that includes means for locally storing a series of logical channel identifiers LCIDs each associated with one radio link service profile RLSP. The means for locally storing is accessed whenever a LCID is taken into use for identifying an active logical channel, and each RLSP includes a set of radio link service parameters at least one of which is a quality of service parameter. In an embodiment, the means for locally storing includes a computer readable memory. The device further includes means for receiving over a wireless logical channel a first data packet bearing a LCID that establishes a flow. In an embodiment, the means for receiving includes a transceiver. Further, the device includes means for determining, using the means for locally storing, if an RLSP is associated with the LCID. Responsive to the means for determining that an RLSP is not associated with the LCID is means for associating the LCID with a designated default RLSP, and also means for processing the first data packet using the designated default RLSP. In an embodiment, the means for determining, means for associating, and means for processing include a processor coupled to the memory and transceiver.

### BRIEF DESCRIPTION OF THE DRAWINGS

In the attached Drawing Figures:

FIG. 1A shows a simplified block diagram of various electronic devices that are suitable for use in practicing the exemplary embodiments of this invention in a GERAN/UTRAN network architecture;

FIG. 1B shows a simplified block diagram of various electronic devices that are suitable for use in practicing the exemplary embodiments of this invention in an E-UTRAN network architecture;

FIG. 2 illustrates protocol stack that embodies service profiles and a flow diagram;

FIG. 3A illustrates peer-to-peer messaging during creation of a radio link service profile for the C-plane;

FIG. 3B illustrates the data flow on the U-plane after the radio link service invoke;

FIG. 4 illustrates a RRC procedure for radio link service profile creation when originated by the BS;

FIG. 5 illustrates a RRC procedure for radio link service profile creation when originated by the UE;

FIG. 6 illustrates a non-limiting example of a message for RRC creation, as well as the constituent information elements of the RLSP CREATION message;

FIG. 7 shows an example of DL originated RLSP Creation;

FIG. 8A shows an example of UL originated RLSP Creation;

FIG. 8B shows an alternative embodiment of UL RLSP Creation;

FIG. 9 illustrates an example of the use of a default RLSP or a pre-configured RLSP;

FIG. 10 depicts peer-to-peer messaging in a GERAN/UTRAN network architecture during creation of RLSP for the C-plane;

FIG. 11 depicts data flow on the U-plane after an RLSP invoke for a GERAN/UTRAN network architecture;

FIG. 12 illustrates an implementation of the exemplary embodiments of this invention with default, pre-configured and customized RLSPs; and

FIGS. 13A and 13B illustrate two examples of the use of this invention with a default RLSP and with a default/preconfigured or customized RLSP, respectively.

FIG. 14 is a process flow diagram showing process steps according to an embodiment of the invention where a packet is sent with an unregistered LCID.

FIG. 15A is a signaling diagram for a BS broadcasting a message that restricts a total number of unregistered logical channels that may be used in the cell.

FIG. 15B is an exemplary table of the contents of the broadcast message of FIG. 15A.

FIGS. 16A and 16B are similar to FIGS. 15A-15B, but for the case where the base station signals the restriction to a particular UE during a cell establishment.

### DETAILED DESCRIPTION

The non-limiting embodiments of this invention are related at least in part to the E-UTRAN. E-UTRAN provides a new protocol architecture intended to efficiently serve traffic in the packet-switched (PS) domain. The IP protocol is used for transport in the RAN, as well as over the air interface.

The use of the non-limiting embodiments of this invention provide for low control-plane setup and user traffic latencies, provide good support for internet protocol based packet-switched traffic, and avoid delays caused by conventional hierarchical bearer negotiations between several network elements.

This protocol structure avoids conventional bearer negotiation between several network elements because the RRC is fully configured in the BS. In the BS, the IP flows are available to an IPCS which allows a user plane traffic flow to interact locally with the MAC.

The exemplary embodiments of the invention described in the incorporated application relate at least in part to the creation (and deletion) of a RLSP. The RLSP is configured by the RRC protocol and allows an IP flow to utilize MAC and PHY protocol services efficiently and flexibly.

In an assumed network architecture of interest to the exemplary embodiments of this invention, a RRC protocol is terminated in the BS and the UE. IP service flows are assumed to be detected by an IP convergence sub-layer (IPCS) included in the radio interface protocol stack in the BS, and passed to a MAC sub-layer in the BS. The RRC is assumed to be capable of configuring a RLSP, which describes the L2 QoS requirements of a radio link service, to the MAC sub-layer so as to implement the QoS functions for each flow.

As was noted above, the latency caused by radio bearer setups (as seen in UTRAN) can be mitigated by the use of pre-defined RLSPs (such as “default RLSP” and “pre-configured RLSP”) as defined in accordance with the exemplary embodiments of the invention described in the incorporated application. However, to use RLSPs efficiently in the E-UTRAN system, the FlowID management in the MAC sub-layer, as a consequence, needs to be developed and adjusted.

In detail, the use of RLSP in E-UTRAN introduces the following two issues.
The use of the pre-defined RLSP allows some packets to be sent even before the QoS management signaling between the BS and the UE. The MAC layer thus would benefit from having a FlowID management framework in which the receiver can know in what way the RLSP corresponds to the FlowID, and how the flow should be treated in this case.
The use of RLSP also introduces the flexibility to reconfigure the QoS requirements. However, even when the RLSP is reconfigured on the fly, the FlowID should not be changed. This is true at least for the reason that if the FlowID is changed on the fly, the MAC layer cannot reorder the MAC segments.

Within the overall network framework discussed above, the exemplary embodiments of this invention provide an efficient and flexible FlowID management so that the MAC layer can support different types of RLSPs, and offer a means for flexibly updating the RLSP of a flow. Since the FlowID management is tightly related to the queuing management in the MAC layer, the efficiency of such FlowID management is important for efficient radio performance (i.e., low-latency and high-throughput air interface).

In exemplary embodiments of this invention the FlowID space is partitioned into default and registered/unregistered FlowIDs. Different default service profiles are associated to default FlowIDs and unregistered FlowID in advance so that unregistered FlowIDs are handled differently from the default FlowIDs. By using this mechanism, data can be transmitted before the service profile configuration (with low latency) by using unregistered FlowID, even if the RLSP for the corresponding IP flow is not the default one. Furthermore, the service profile can be reconfigured later for unregistered and registered FlowID.

It can be noted that the FlowID in the MAC layer may be referred to as a Logical Channel FlowID (LCFID), or as a Logical Channel ID (LCID).

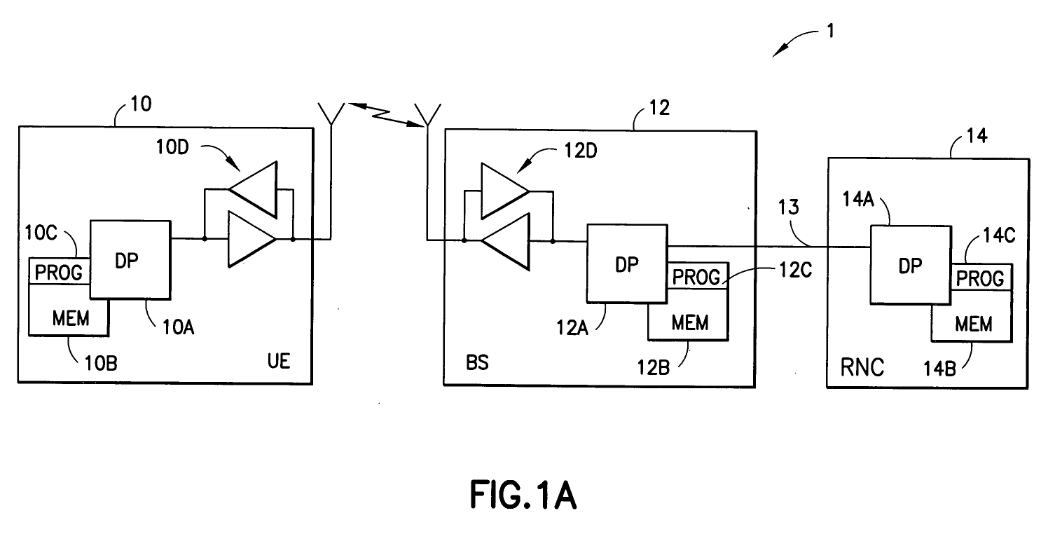

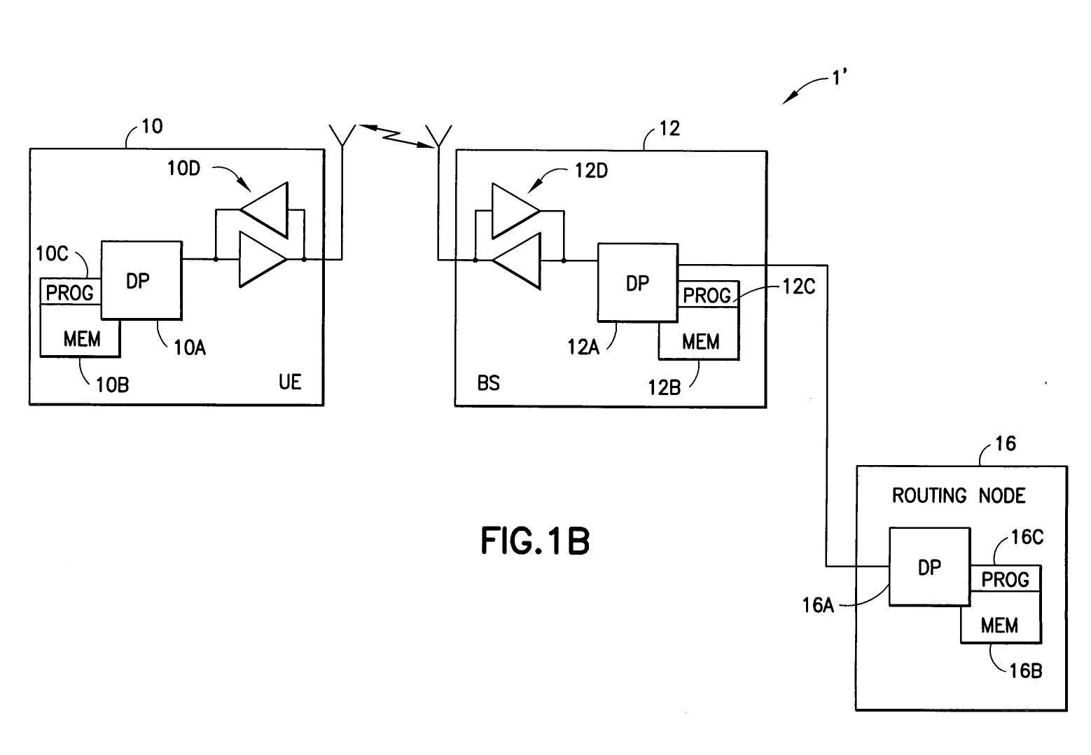

Reference is made first to FIG. 1A for illustrating a simplified block diagram of various electronic devices that are suitable for use in practicing the exemplary embodiments of this invention. In FIG. 1A a wireless network 1 includes a UE 10, a base station (BS) 12 and a RNC 14. The UE 10 includes a data processor (DP) 10A, a memory (MEM) 10B that stores a program (PROG) 10C, and a suitable radio frequency (RF) transceiver 10D for bidirectional wireless communications with the BS 12, which also includes a DP 12A, a MEM 12B that stores a PROG 12C, and a suitable RF transceiver 12D. The BS 12 is coupled via a data path 13 to the RNC 14 that also includes a DP 14A and a MEM 14B storing an associated PROG 14C. At least the PROGs 10C and 12C are assumed to include program instructions that, when executed by the associated DP, enable the electronic device to operate in accordance with the exemplary embodiments of this invention, as will be discussed below in greater detail.

It should be noted that exemplary embodiments of this invention may also be employed in a network architecture (e.g., E-UTRAN), where the functionality is solely between the BS 12 and the UE 10, where the BS 12 has a networking connection to the E-UTRAN and further to the core network. As can be seen in the exemplary wireless network 1′ of FIG. 1B, the BS 12 is not coupled via a data path to the RNC 14, as shown in the example of FIG. 1A, but instead is coupled to a routing node 16 in a packet network. In this case the routing node 16 may be assumed to include a data processor (DP) 16A and a memory (MEM) 16B that stores a program (PROG) 16C, where the PROG 16C is provided so as to implement the routing node 16 aspects of this invention. The exemplary embodiments of this invention may also be used to advantage with WLAN and Ad Hoc network architectures, as two non-limiting examples. Thus, it should be apparent that the use of the exemplary embodiments of this invention does not require the presence of the RNC 14 of FIG. 1A.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 10A of the UE 10 and the other DPs, or by hardware, or by a combination of software and hardware.

The MEMs 10B, 12B, 14B and 16B maybe of any type suitable to the local technical environment and may be implemented using any suitable data storage technology, such as semiconductor-based memory devices, magnetic memory devices and systems, optical memory devices and systems, fixed memory and removable memory. The DPs 10A, 12A, 14A and 16A may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of the invention described in the incorporated application provide a cellular and wireless communication system, without radio bearers, capable of operation fully in the packet-switched domain.

The RLSP is provided for an upper layer IP flow. The RLSP configures the MAC and PITY by setting quality parameters and transport parameters for radio transmission in the user plane.

The exemplary embodiments of the invention described in the incorporated application encompass a means to configure a RLSP locally in the UE and locally in the BS for both for UE-originated and BS-originated traffic.

Additionally, the exemplary embodiments of the invention described in the incorporated application provide novel peer-to-peer signaling to invoke a pre-configured RLSP, or to create a customized RLSP in a dynamic manner.

A RLSP includes a unique profile identity per UE having a set of quality parameters and transport parameters. A RLSP is characterized in that it is assigned per flow, and is fully sufficient to represent any IP traffic over the radio link. This is an important feature of the RLSP, as the IP does not include radio mobility or radio resource control features.

The exemplary embodiments of the invention described in the incorporated application pertain at least in part to:
creation of an RLSP;
assignment of an RLSP to an IP flow;
signaling to invoke or to create a RLSP peer-to-peer.

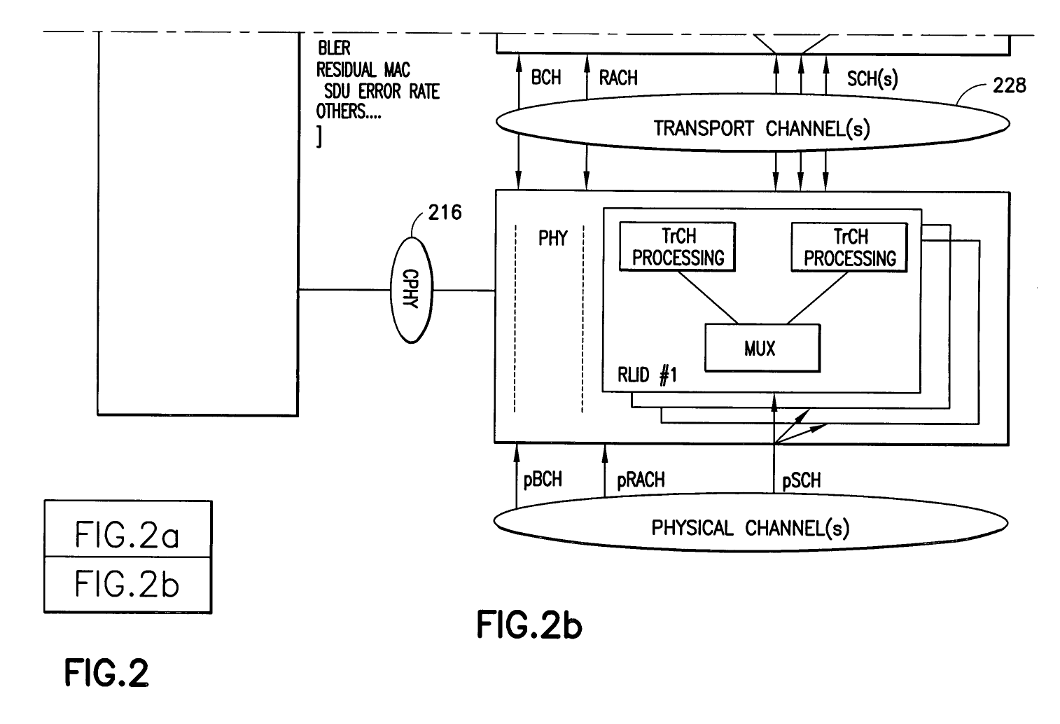

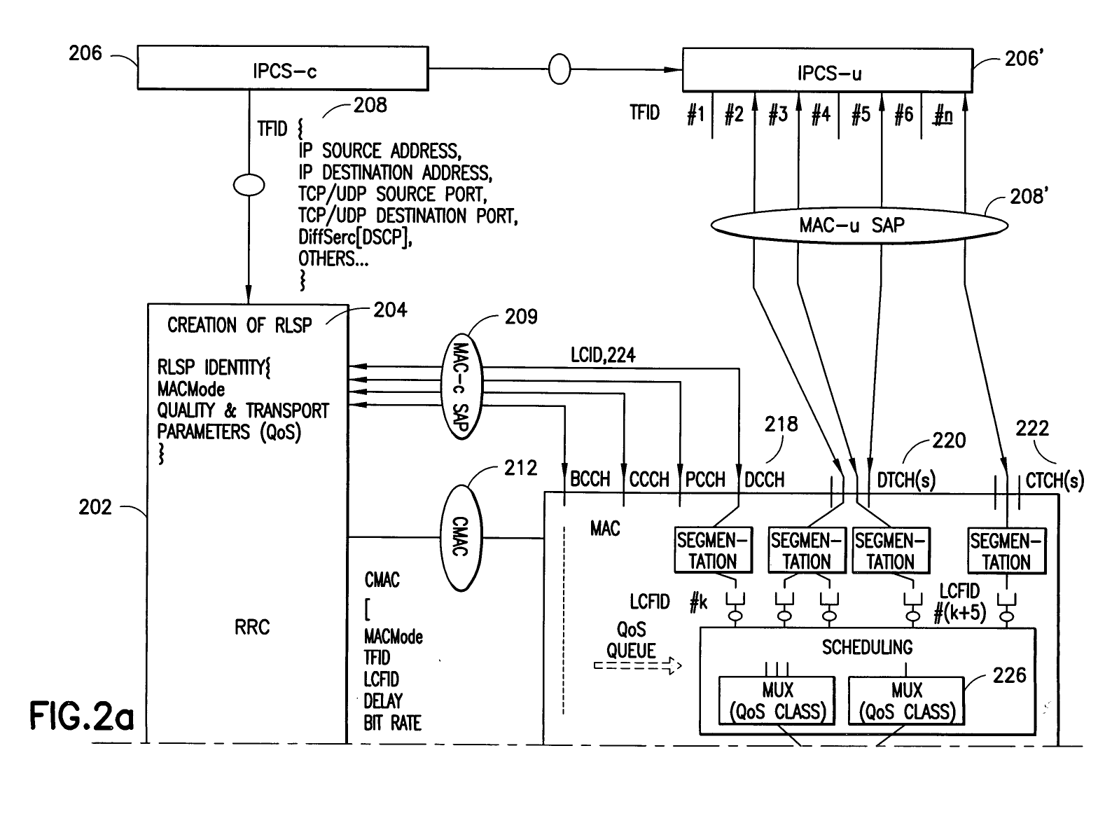

Creation of RLSPs: Referring to FIG. 2, the RRC 202 can, on request from upper layers (through the IPCS 206), create an RLSP 204. At creation, the RRC 202 performs admission control and selects parameters for the RLSP 204, based on information from upper layers. These upper layers may include Session Initiation or Session Description protocols. The upper layer protocol provides desired quality requirements to the IPCS 206 as differentiated services (DiffServ). The IPCS 206 denotes a flow in its preferred way and assigns a TFID 208 to every flow.

A flow may be defined to be, as a non-limiting example, a combination of IP Source Address, IP Destination Address, Source Port (TCP or UDP port) and Destination Port (TCP or UDP port).

The IPCS 206 delivers the TFIDs 208 and quality requirements of the flow (based on DiffServ) to the RRC in the control plane (C-plane) via the RRC SAP 209. Thus, the RRC 202 can configure and control the MAC 210 via CMAC 212, and PHY 214 via CPHY 216, for transport in the user plane (U-plane). FIG. 2 shows an example of a protocol stack for use with the RLSP 204, and a flow diagram.

The RLSP 204 can be:
a default RLSP
default for the C-plane, DCCH 218.
default for the U-plane, DTCH 220.
a pre-configured RLSP; or
a customized RLSP.

Briefly, a RLSP 204 can be created locally and communicated peer-to-peer. The RLSP 204 may be considered to be primarily local. At a minimum, a RLSP 204 is default, which is fully local. In a typical case, the RLSP 204 is pre-configured, in which case peer-to-peer signaling is employed to link a flow (TFID 208) and a profile (RLSP 204). For a flow that carries differentiated services, a RLSP 204 with multiple logical channel flows (LCID) may be defined, such that one logical channel flow serves exactly one differentiated service.

Default RLSP: The default RLSP is always reserved for the C-plane DCCH 218. For the U-plane DTCH 220 or CTCH 222, there is also a default RLSP defined for each logical channel type. It can be noted that the CTCH 222 may be replaced by a MTCH, which is the logical channel for MBMS.

The RLSP default for the DTCH 220 may be used primarily for: a) connection request/confirm packets; b) session initiation traffic; c) or other IP control packets (U-plane traffic). It may also be used for application flows (for example, short message service and e-mail).

One benefit of the default RLSP is that it exists in the UE 10 and in the BS 12, both in the idle and in the active state, and is readily available for use. Thus, a default RLSP is characterized in that it does not require invocation by a RRC procedure.

Pre-configured RLSP: The pre-configured RLSP is defined locally. Any number of pre-configured RLSPs may exist, but they preferably all have a unique reserved identity. A pre-configured RLSP is characterized in that it is implicitly defined, e.g. by a standard specification, and thus it is available locally in the UE 10 and in the BS 12, where it can be invoked by a RRC procedure. The invoke procedure may include a small message that contains the number reference (identity) of the pre-configured RLSP. Alternatively, pre-configuration of the RLSP may occur in a network-specific way instead of being defined by a standard. In the network-configured case, the UE 10 may load the pre-configured RLSP(s) before the actual use, e.g., during Initial Access to, or Registration with the network.

Customized RLSP(s): The customized RLSP is defined locally at the originating entity (UE 10 or BS 12) and its creation is communicated peer-to-peer. The RRC may allocate any free identity to the customized RLSP, which is neither default nor pre-configured. The customized RLSP is characterized in that it contains (where BLER indicates block error rate):

| RLSP identity{ | |
|---|---|
| MACmode= { | |
| Acknowledge / Non-Acknowledge, | |
| In-order delivery / out-of-order delivery, | |
| } | |
| Delay { | |
| nominal, | |
| max. | |
| } | |
| Bit rate { | |
| Guaranteed minimum value, | |
| Expected value. | |
| } | |
| BLER { | |
| Target BLER. | |
| } | |
| Residual MAC SDU error rate | { |
| Max. | |
| } | |
| others.... | |
| } | |

By the use of the exemplary embodiments of the invention described in the incorporated application, every IP flow is uniquely assigned to a single RLSP 204. If the IP flow is defined to support differentiated services (DiffServ) by the means of its Diffserv field in the IP header, then each such differentiation is assigned to a unique logical channel flow (LCID) of the assigned RLSP 204.

It is possible to assign a single RLSP 204 to more than one TFID 208 consequently, after the previous flow assignment is terminated. It is also possible to assign a single RLSP 204 to more than one TFID 208 simultaneously, if the TFIDs are of different radio links (such as a different UE 10 served by the BS 12). As a further extension of the exemplary embodiments of the invention described in the incorporated application, it is possible to assign a single RLSP 204 to more than one TFID 208 of a single UE 10 simultaneously, so long as its logical channel types or logical channel numbers differentiate them uniquely.

Discussed now is the usage of the RLSP 204 in the IP flow in the context of MAC SDU delivery. In accordance with the exemplary embodiments of the invention described in the incorporated application, as the LCID is applied for transport of SDU reception at the MAC-u SAP 208′ of U-plane logical channel (TCH 220, 222), or at the MAC-c SAP 208 of C-plane logical channel (DCCH 218), a particular LCID 224 is applied depending on DiffServ attributes of the SDU. SDUs from each logical channel flow (LCID 224) are segmented and multiplexed to MAC PDUs. Thus, a single Transport Block is defined as a packing of one or several MAC segments having the same LCID 224.

The exemplary embodiments of the invention described in the incorporated application allow any multiplexing of logical channel flows in the MAC 210. For example, different logical channels may be multiplexed together and transported by one RLSP 204 and one LCID 224, if otherwise practical. Or, alternatively, a single logical channel may be split into different logical flows that are transported by mutually different RLSP 204 and LCID 224. The description given above of the exemplary embodiments of the invention described in the incorporated application omits MAC multiplexing 226, as the described mode is assumed to be most efficient in terms of processing power and delay. It can be noted that multiplexing occurs in any case at the Transport Channel 228 level.

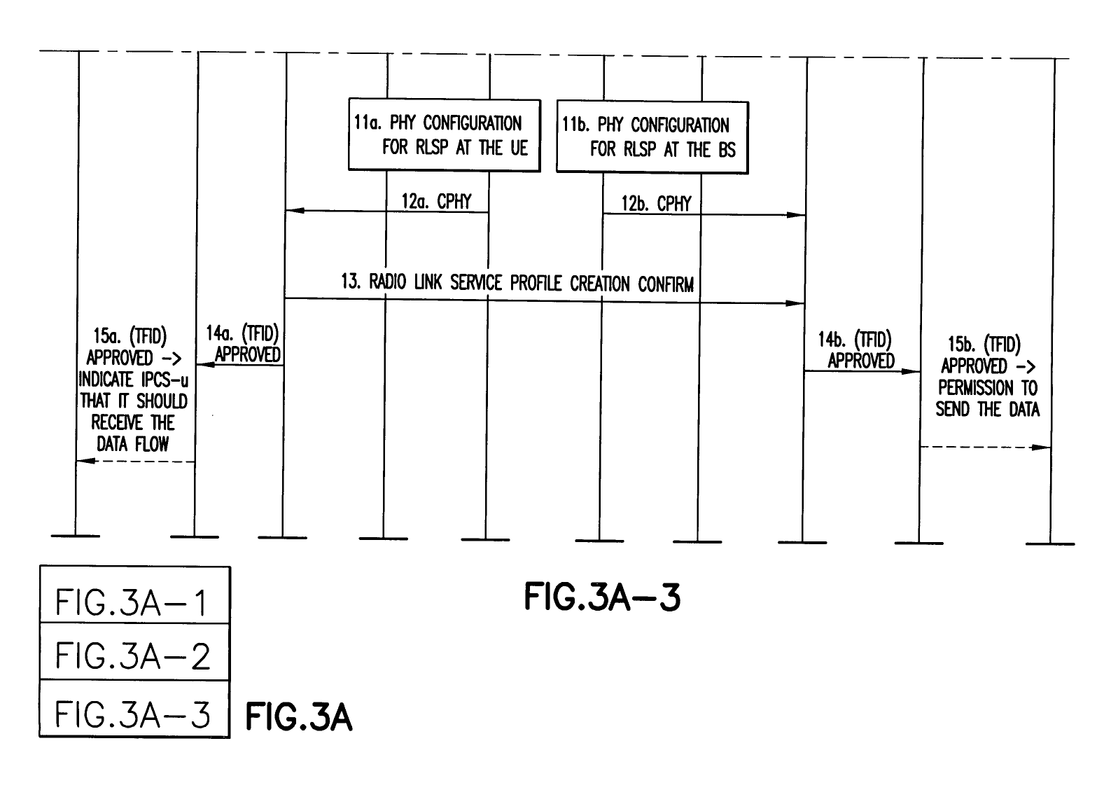

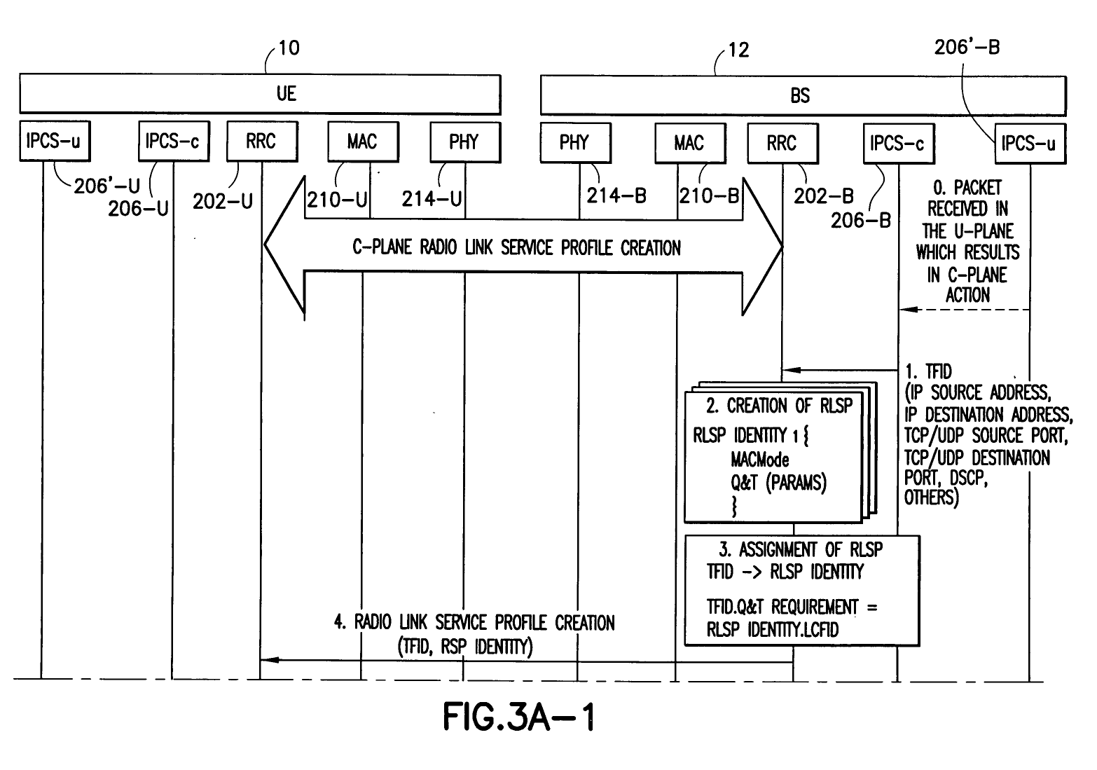

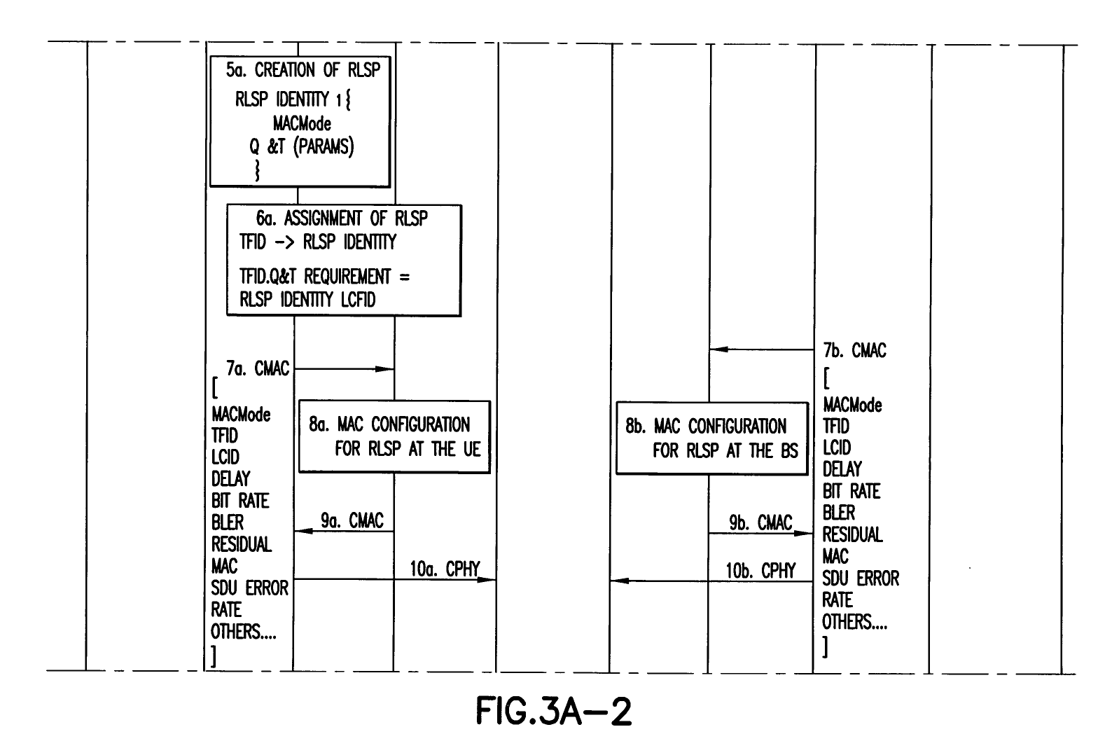

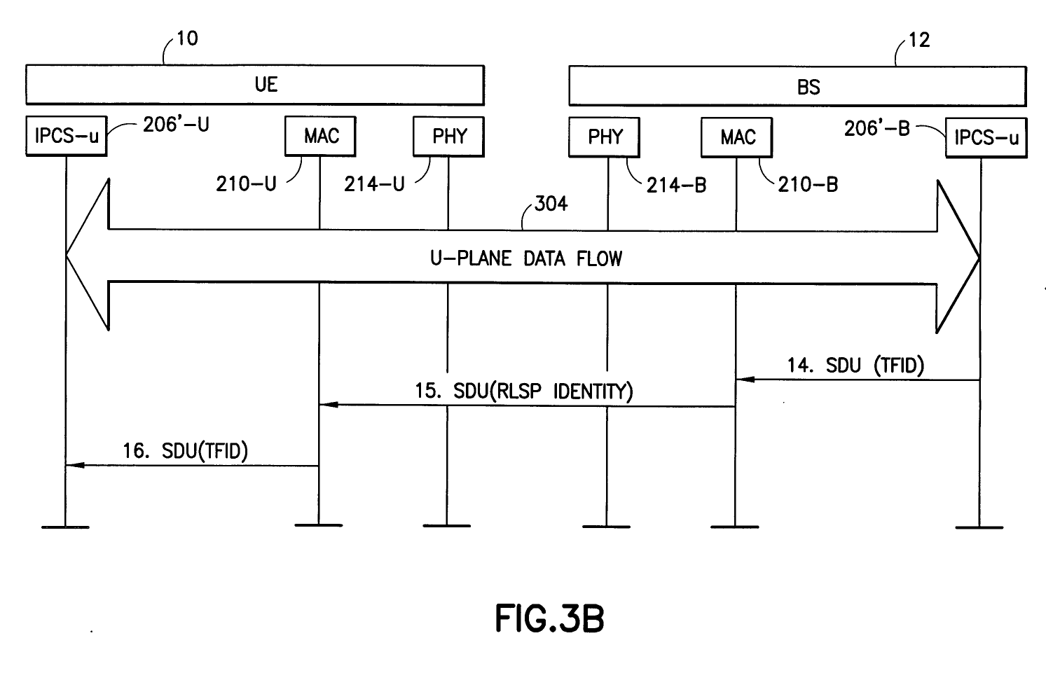

Reference is made to FIG. 3A for illustrating the creation of a RLSP per radio link for the C-plane. It should be noted, however, that the use of the exemplary embodiments of the invention described in the incorporated application are not restricted to either the UL or the DL, and pertains to both DL as well as UL originated IP flows. The numbered message flows are described as follows. The IPCS, RRC, MAC, and PHY are as described with respect to FIG. 2, but for FIGS. 3A-3B are appended with the suffix U or B to indicate the respective UE 10 or BS 12 perspective.

RLSP creation is initiated in the c-plane 206-B by receipt of a packet from the u-plane 206′-B at message 0.

The TFID presents at message 1 an IP flow by means of a combination of parameters present in the IP headers (e.g., combination of IP Source Address, IP Destination Address, Source Port, Destination Port, DSCP and possibly others), as noted previously.

The RRC 202-B creates at message 2 a RLSP and defines a set of radio link parameters and identifiers (RLSP identity for C-plane and LCID for U-plane). The RRC generates parameters locally that describe the radio link quality and transport requirements for this combination of RLSP and LCID per user.

The RRC 202-B assigns uniquely at message 3 an upper layer flow (TFID) to a RLSP, known by the combination of RLSP in the C-plane and LCID in the U-plane.

The RRC 202-B signals at message 4 relevant information elements of the full service profile to its peer entity (RRC 202-U of the UE 10).

At the peer RRC entity 202-U, a local copy of the RLSP is created and assigned, respectively at message 5.

The RRC 202-U, 202-B in the UE 10 and in the BS 12 (respectively) locally configure MAC 210-U, 210-B and PHY 214-U, 214-B at message 6 by the specified set of radio link service parameters. By this means, the RLSP and LCID are available for MAC 210-U, 210-B and PHY 214-U, 214-B as a reference to be used in the control plane 206-U, 206-B (RLSP) and user plane 206′-U, 206′-B (LCID), respectively.

The RLSP is confirmed at message 7 by the RRC 202-U, 202-B. Thus, an IP flow is fully represented by these defined local settings only.

The usage of the RLSP can be characterized as follows, with reference to FIG. 3B, for the U-plane 304.

With every SDU from IPCS-u (206′-U or 206′-B) through MAC-u SAP (210-U or 210-B), the MAC receives at message 14 a TFID and DiffServ, which the MAC knows to uniquely associate to the LCID and parameters configured by the RRC in the C-plane through the CMAC SAP.

The LCID is present in the MAC headers at message 15. Actually, different LCIDs are present in MAC headers only if different LCIDs exist in the same Transport Block.

The receiver MAC (210-U or 210-B) converts back the SDU [LCID] into an SDU [TFID] at message 16.

Described now, further in accordance with the exemplary embodiments of the invention described in the incorporated application, are examples of an RRC procedure for RLSP creation.

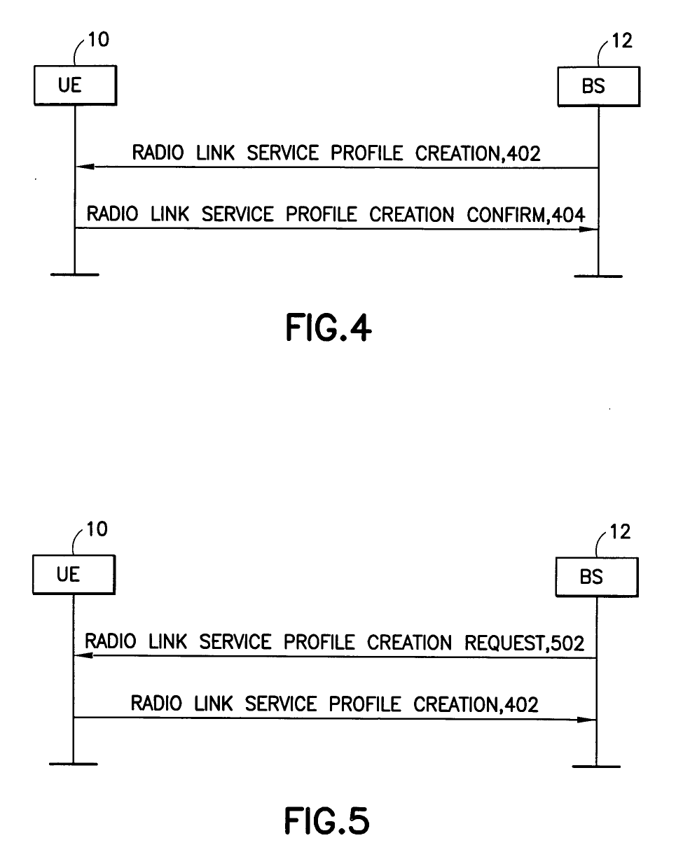

The RRC peer-to-peer signaling, when the radio link service creation is originated by the BS 12, includes RLSP CREATION 402 and RLSP CONFIRM 404 messages as shown FIG. 4. In the case where the radio link service creation is originated by the UE 10, the RRC signaling includes RLSP REQUEST 502 and RLSP CREATION 402 messages as shown in FIG. 5.

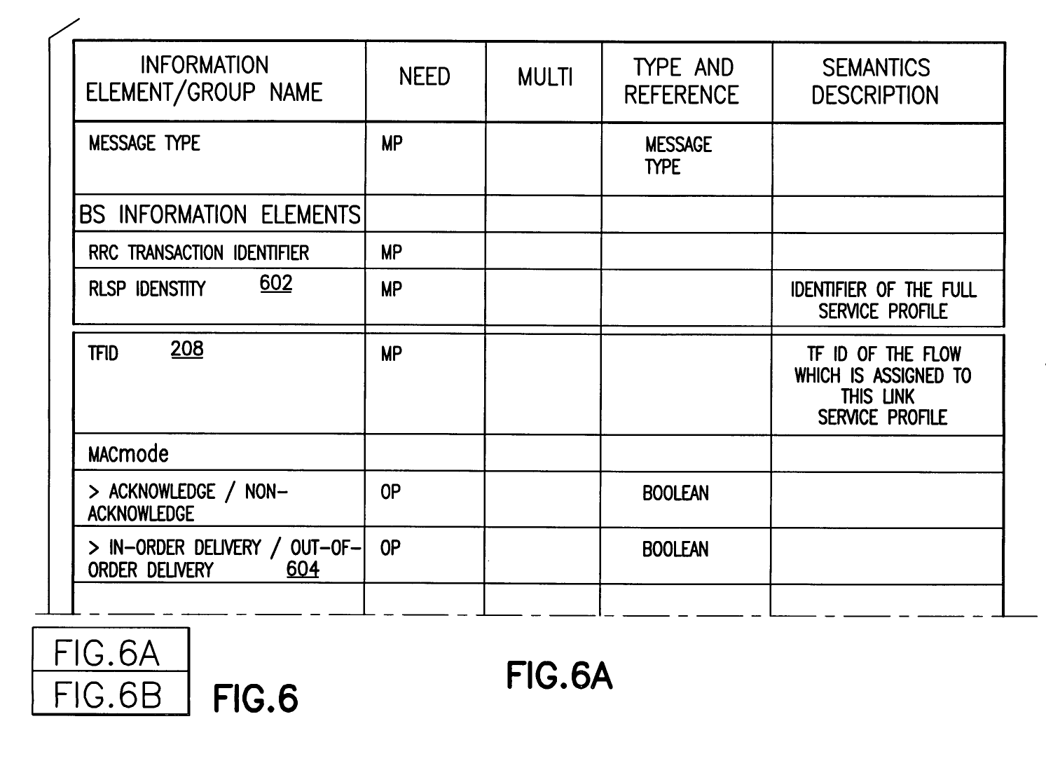

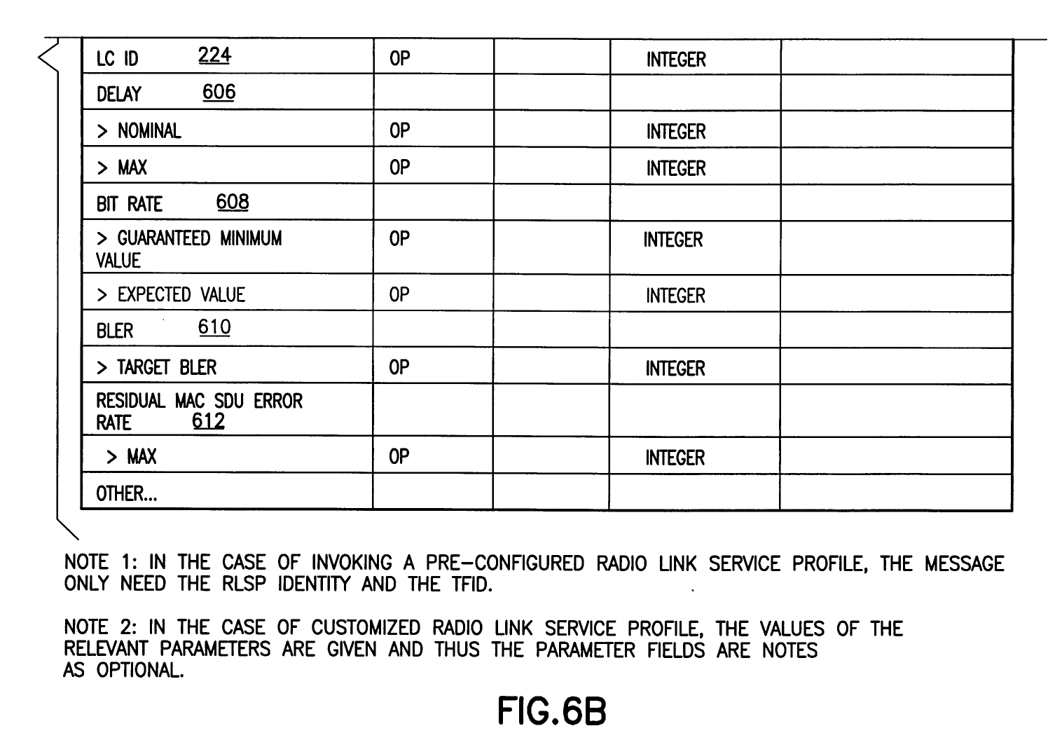

With regard now to examples of signaling in accordance with the exemplary embodiments of this invention, the RRC message, as well as the information elements contained in the RLSP CREATION 402, are described and shown in FIG. 6. As can be seen, the RRC message whose elements are shown in FIG. 6 include an identifier for the full service profile including RLSP identifier 602, TFID 208 and LCID 224 as well as delivery order (e.g., real time/non-real time) 604, quality parameter delay 606, rate 608, BLER 610, and residual error rate 612. The RLSP identifier 602 may identify the message for ready retrieval from storage in a memory when this RLSP is invoked after being created.

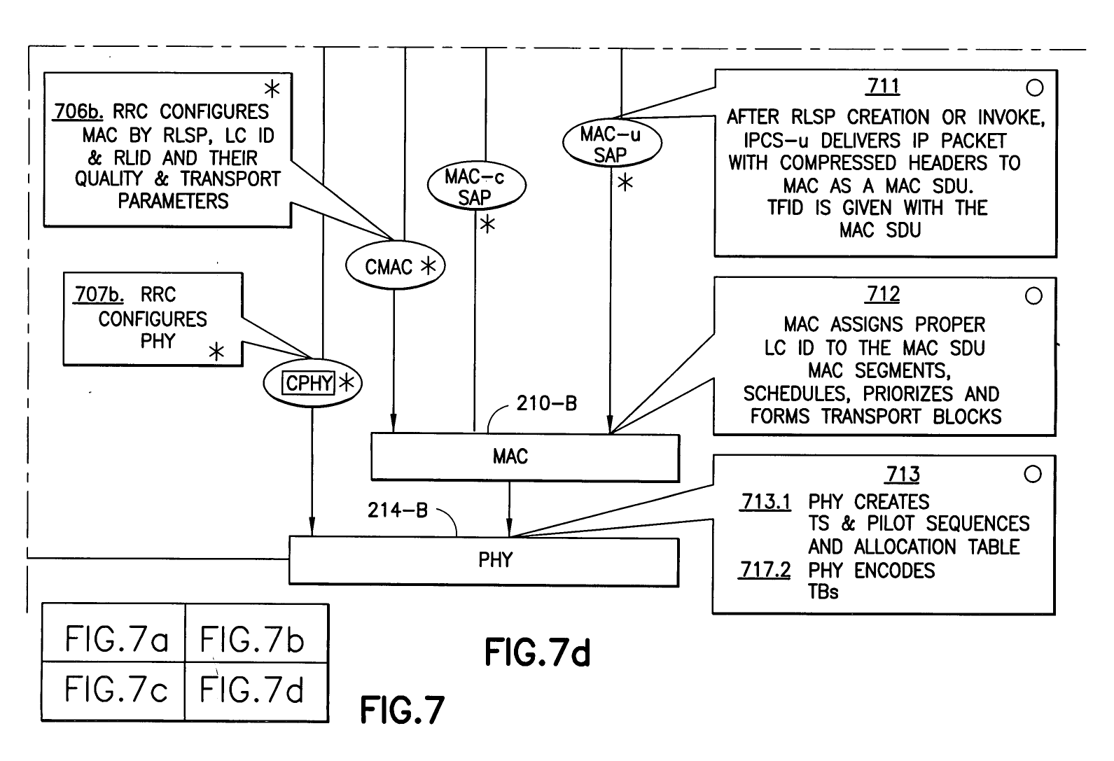

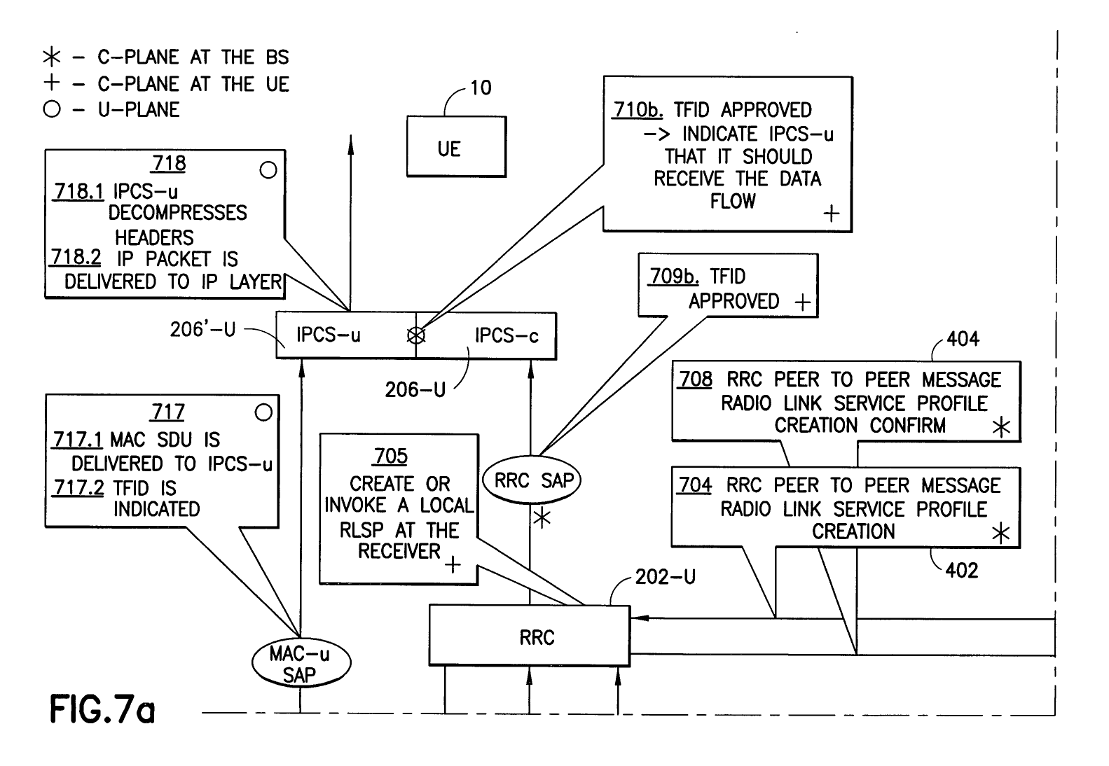

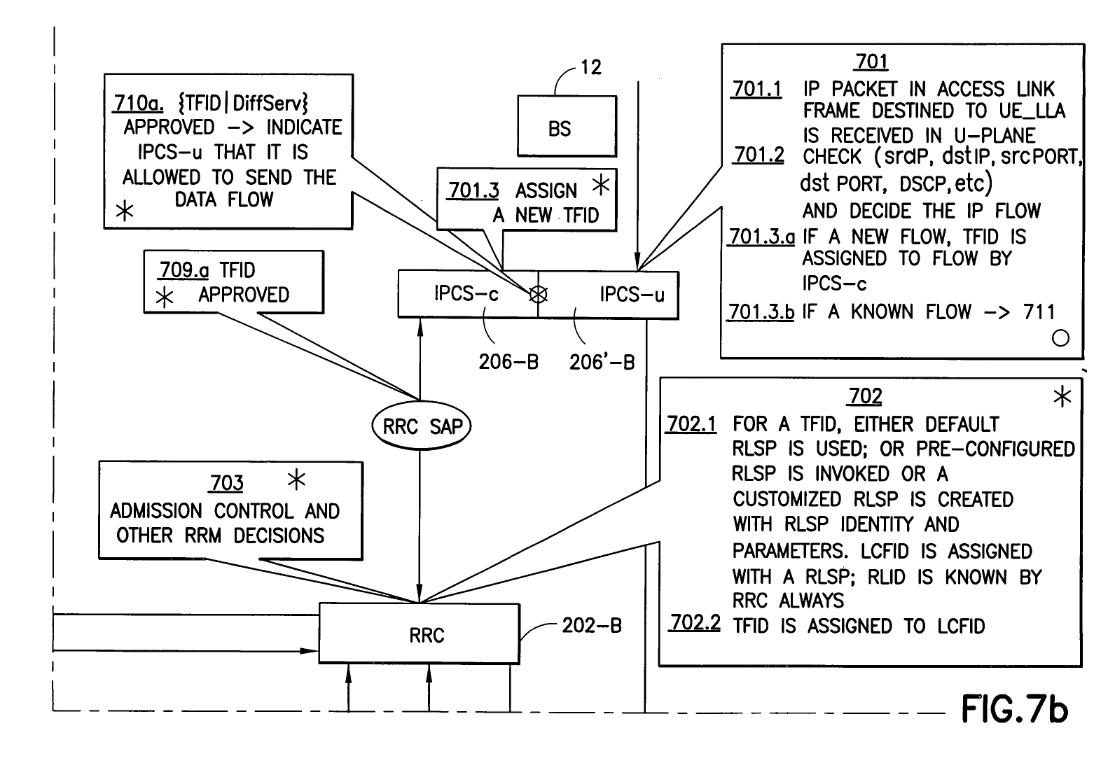

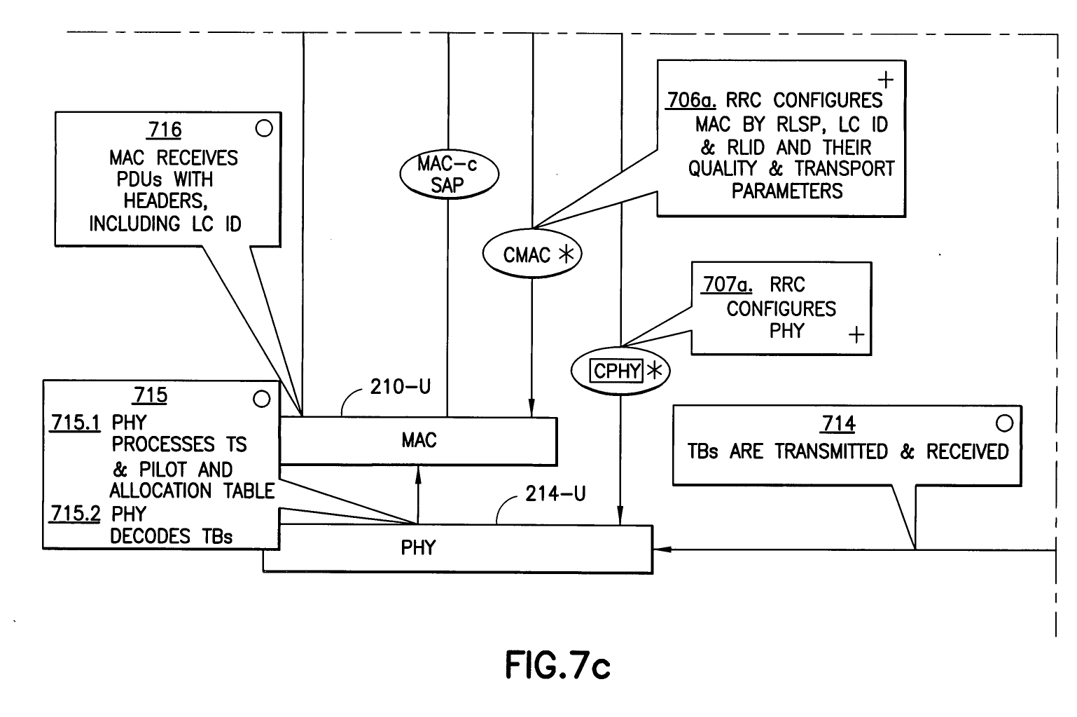

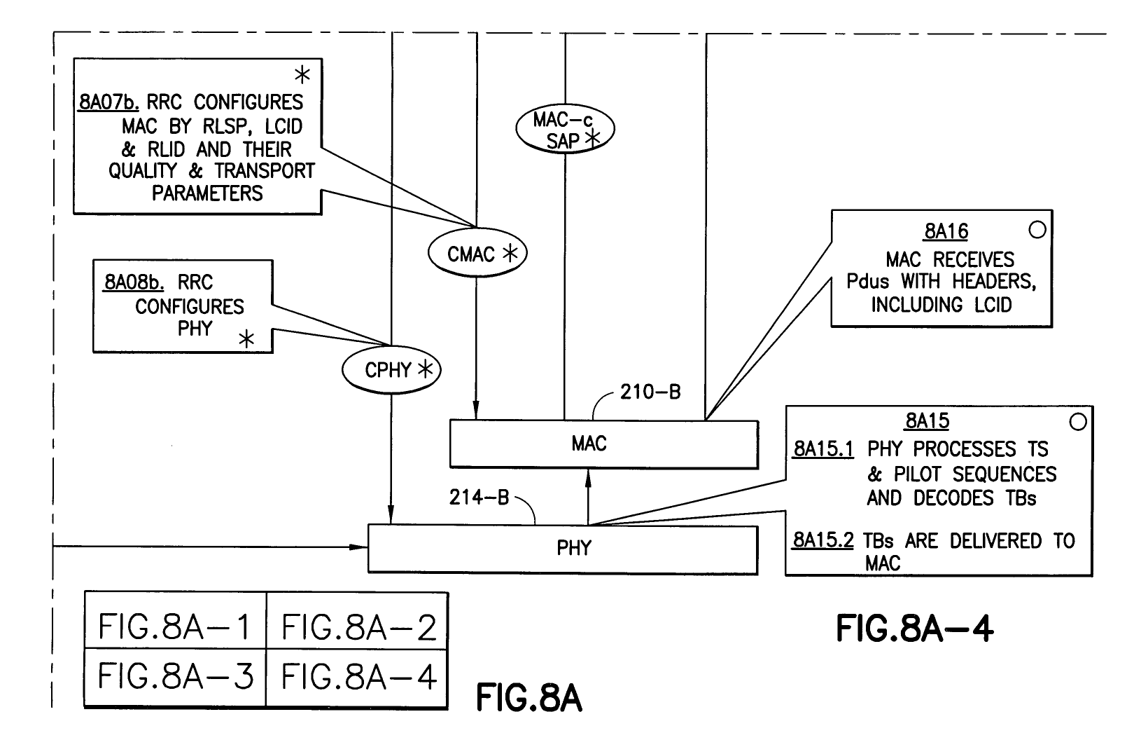

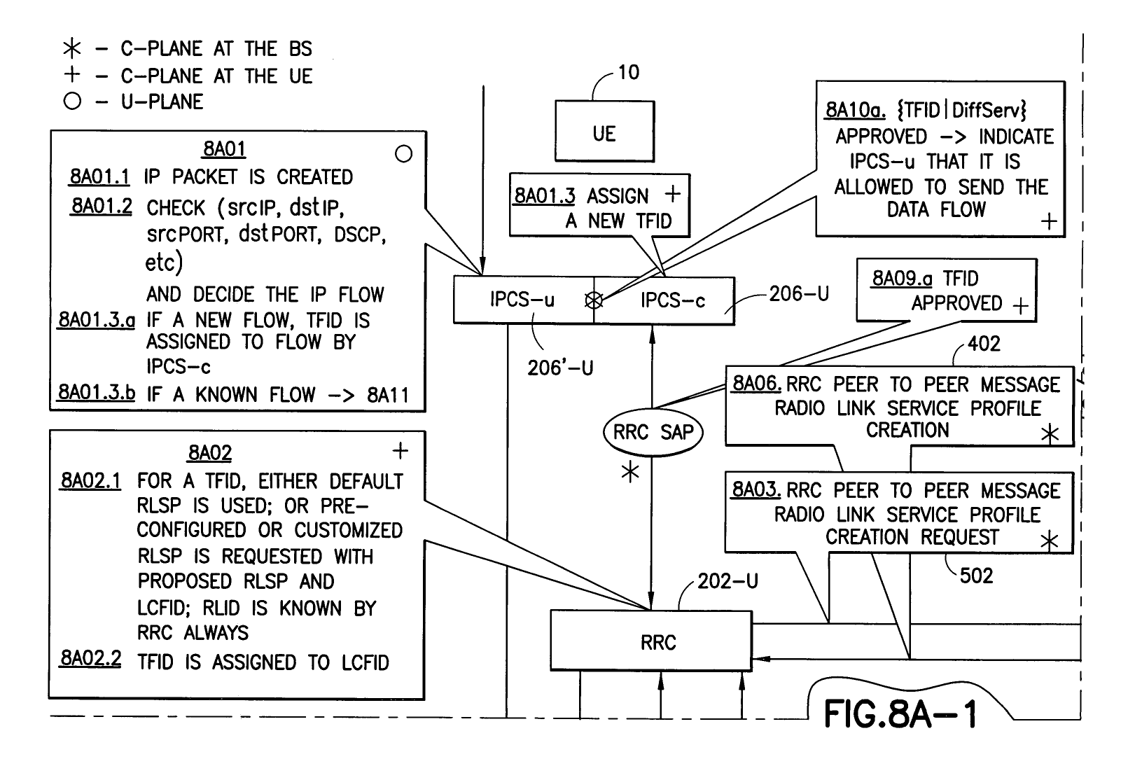

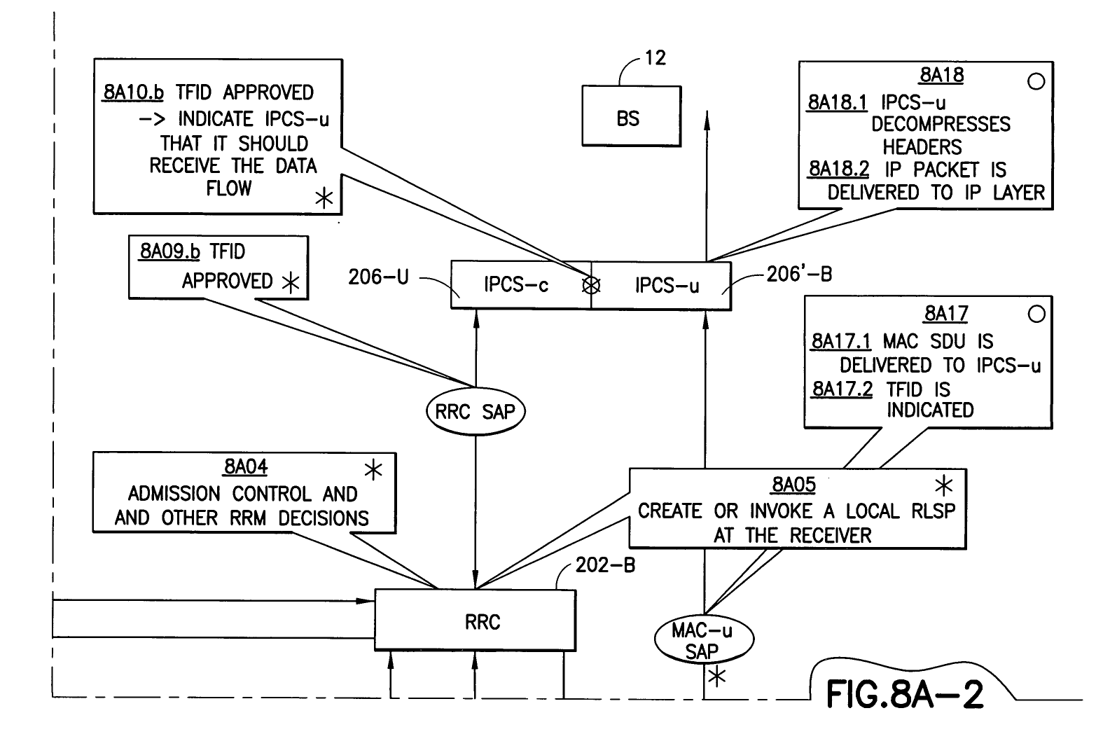

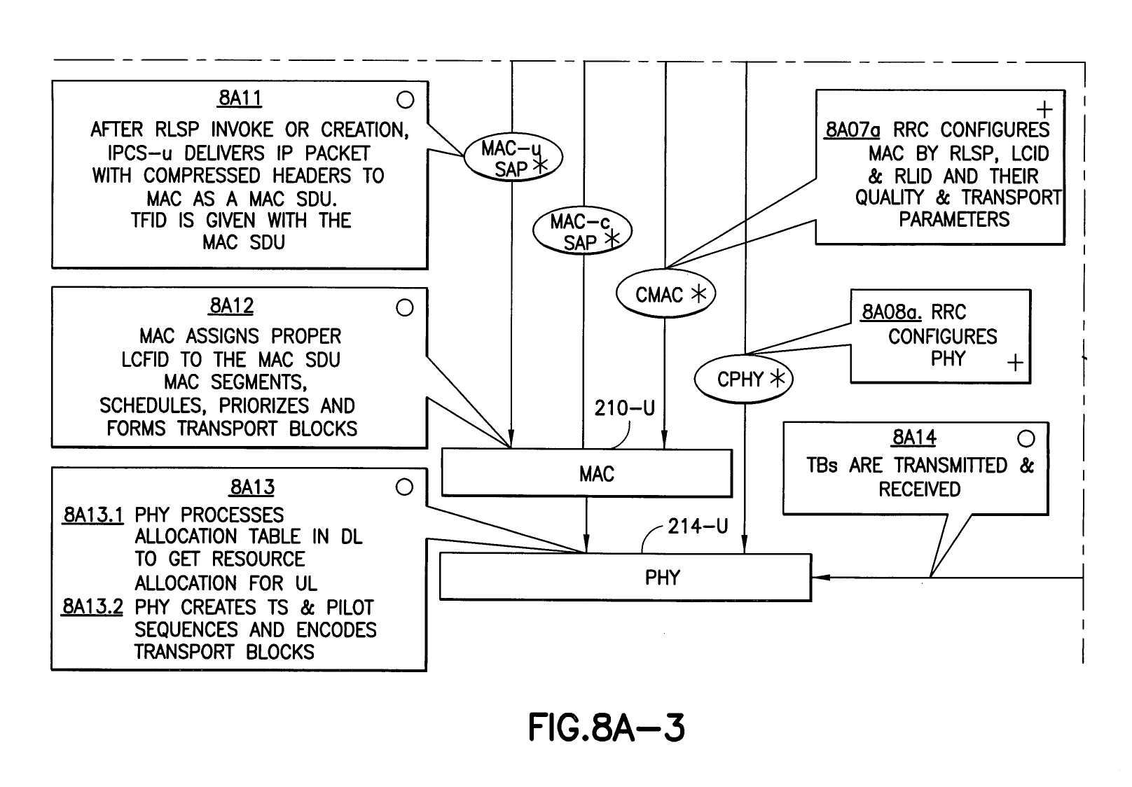

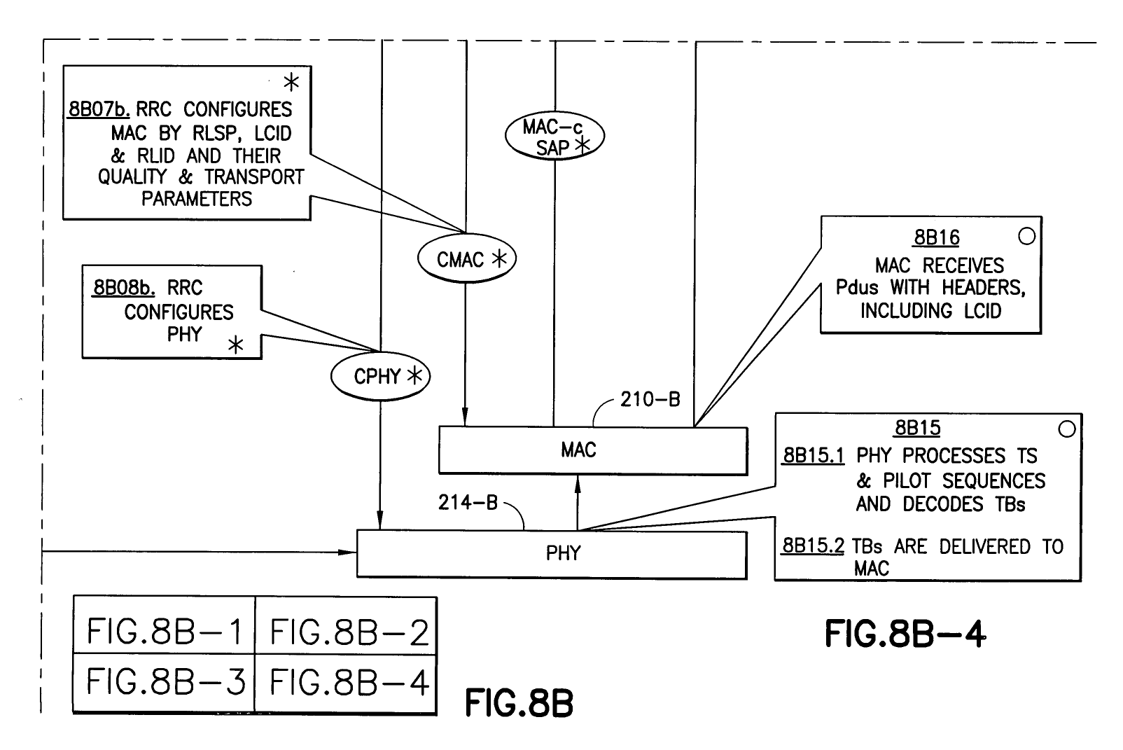

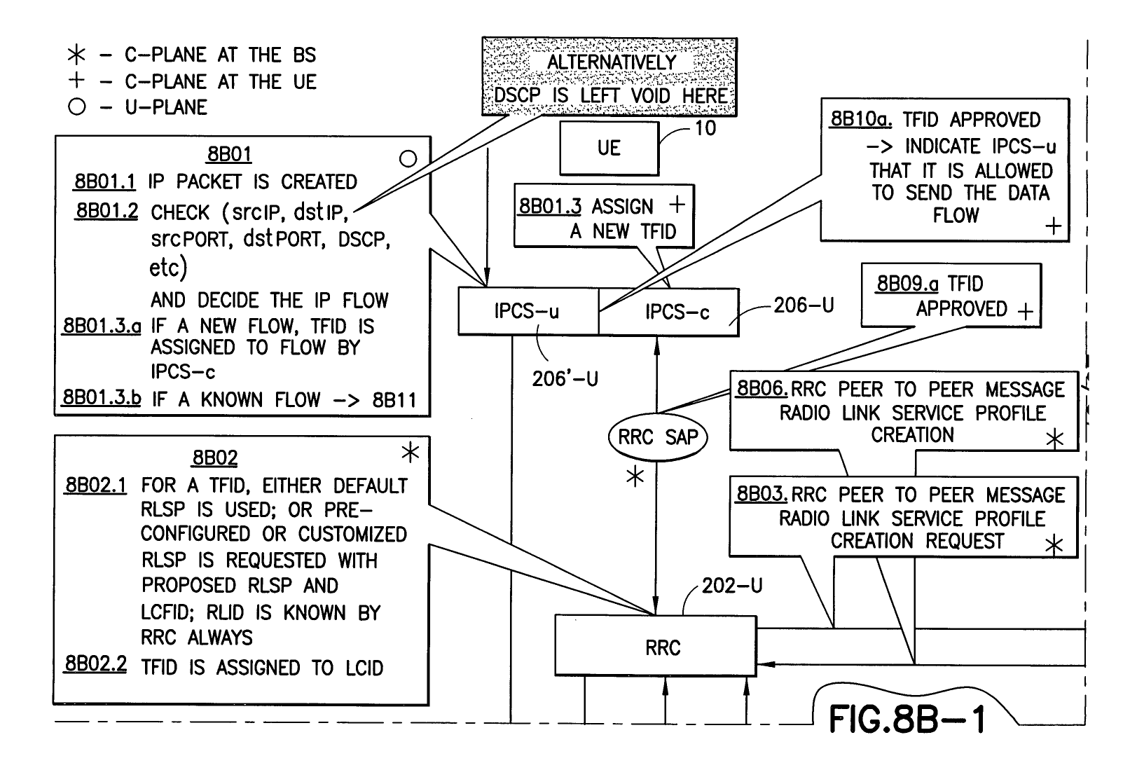

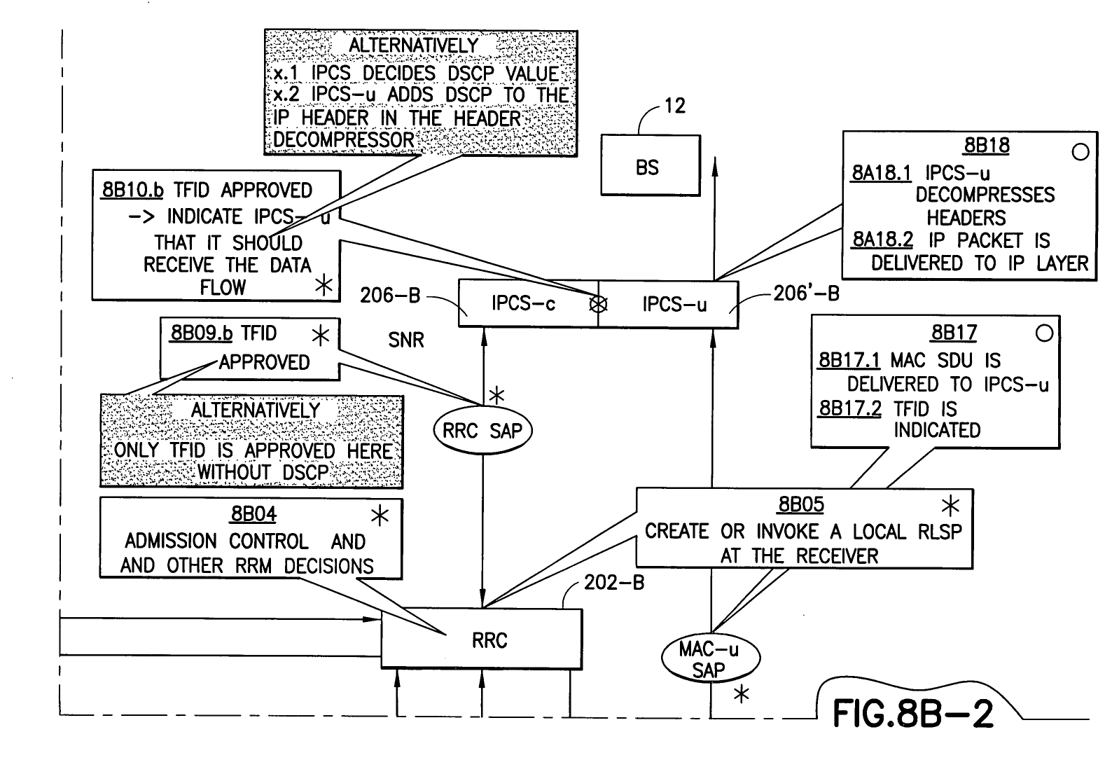

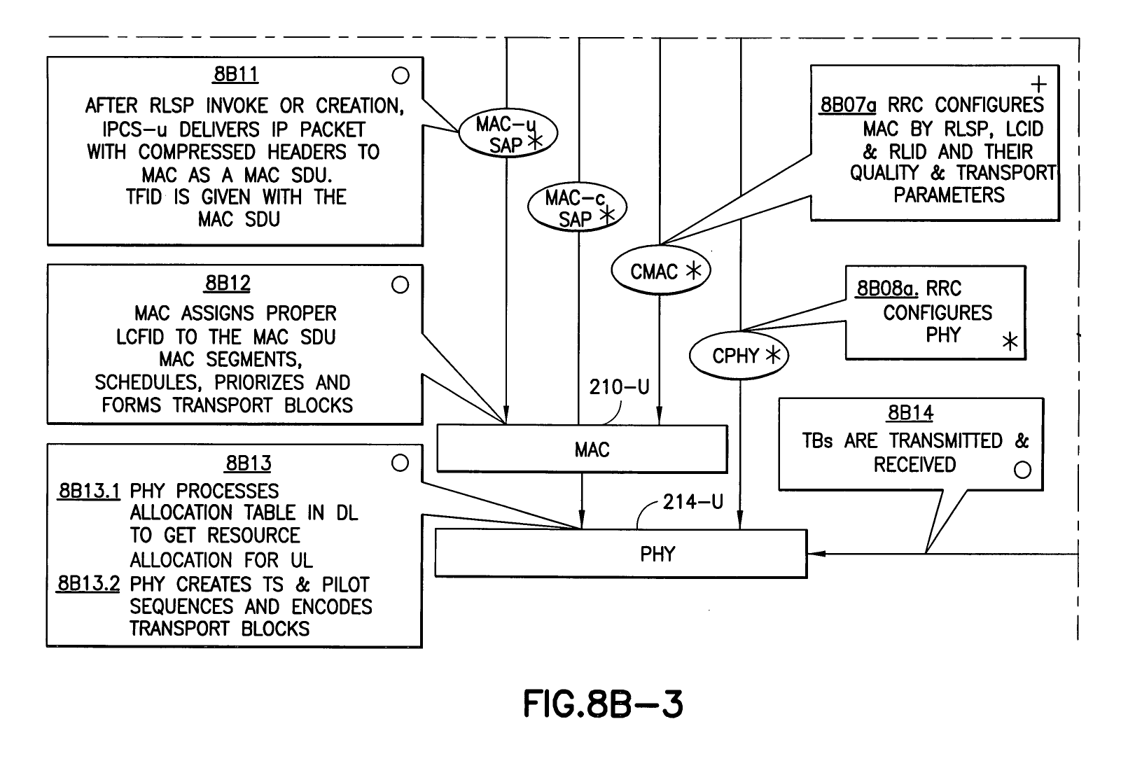

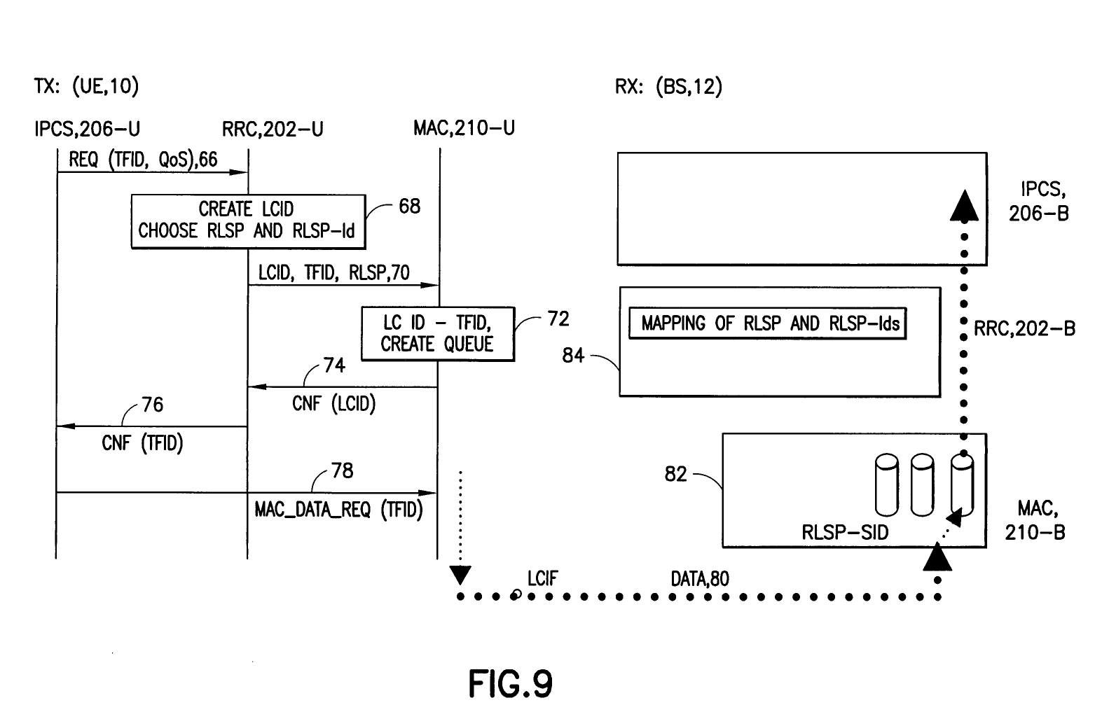

Reference may also be made to FIG. 7 for showing a non-limiting example of DL originated RLSP Creation, to FIG. 8A for showing a non-limiting example of UL originated RLSP Creation; to FIG. 8B for showing another non-limiting example of UL RLSP Creation, and to FIG. 9 for showing an example of the use of the above-described default RLSP or pre-configured RLSP. In FIGS. 7, 8A and 8B the numbered blocks define the general sequential order of operations and message flows. The legend shows those blocks identified with a * as in the c-plane of the BS 12; those identified with a + as in the c-plane of the UE 10, and those identified with a 0 as in the u-plane. Following is a description of FIGS. 7-9 as detailed in the incorporated application.

Specifically, for RLSP creation and/or invoking thereof in the downlink as shown in FIG. 7, at step 701 several actions occur: 701.1 sees a packet in an access link frame destined to the UE 10 being received in the U-plane, where it is checked 701.2 (e.g., source and destination IP and port, diffserv, etc) to decide an IP flow, and at 701.3a if this is a new flow then a TFID 208 is assigned by IPCS-c 206-B or if this is a known flow then at 701.3b the diagram is skipped to step 711. If this is a new flow at step 701.3a, then in the C-plane at the BS 12 a new TFID 208 is assigned at step 701.3.

Assuming for the moment that this is a new flow, then at step 702 in the C-plane of the BS 12 it is determined at 702.1 whether a default, pre-configured, or new customized RLSP is to be used. The RLSP is assigned to a LCID 224 and the RLID is known already to the RRC. At step 711 the LCID 224 is matched to a TFID 208. Similar to that seen in FIG. 3A, then at step 703 admission control is performed, a RRC peer-to-peer RLSP is created at step 704, and a created or local RLSP is invoked at the receiver of the packet, the C-plane of the UE 10 at step 705. Steps 706a and b show the respective UE 10 and BS 12 configuring their MAC 210-U, 210-B with the RLSP, LCID, and RLID as well as the quality parameters in that RLSP, and their PHY layers 214-U, 214-B at steps 707a and b. The RLSP Creation Confirm message 404 is sent from the BS 12's RRC 202-B to its peer 202-U at the UE 10 at step 708, the TFID is approved on each side at steps 709a and b, and approval is indicated in the respective IPCS-u 206′-B, 206′-U to send (from BS 12) and receive (at UE 10) the data flow on the TFID 208 at step 710a and b. Note that in other embodiments a given network implementation may omit the admission control of traffic flows or IP-packets, in which case the invention may still function without the signaling stages related to the admission control.

Step 711 now applies to both newly created RLSPs and those previously stored locally (e.g., pre-configured or default RLSPs) that are now invoked. There, the packet is delivered to MAC 210-B as MAC-SDU, with which the TFID 208 is given in the U-plane where all further steps of FIG. 7 remain. The MAC 210-B assigns the proper LCID 224 to the MAC SDU and forms transport blocks at step 712. The PHY 214-B creates a transport sequence, pilot sequences and an allocation table at step 713.1 and then encodes the transport blocks at step 713.2. Those transport blocks are transmitted from the BS 12 to the UE 10 at step 714, where the PHY layer 214-U of the UE 10 processes them in reverse at steps 715.1 and 715.2. The UE 10 MAC 210-U receives the packets with headers, including the LCID at step 716, the MAC SDU is delivered to the IPCS-u 206′-U at step 717.1 where the TFID is read at step 717.2, and the packet headers are decompressed at the UE 10's IPCS-u 206′-U at step 718.1 so that the packet can be delivered to the IP layer at step 718.2.

As is evident from FIG. 7, there is not need to involve the RNC 14 in setting up the flow, so packets on that flow may be transferred directly to a routing node 16 without passing through the RNC 14. While the RNC 14 may be included in some of the signaling shown in certain embodiments as a coordination matter, such coordination is not generally necessary with the broader embodiments disclosed herein. The flow is set up with the diffserv field (e.g., in order delivery/out of order delivery field 604 of FIG. 6), so packets may be routed directly from the BS 12 to a routing node 16 on an IP network such as the Internet (Intranet or dedicated operator owned section of an IP net), and in reverse directly from the routing node 16 to the BS 12 for wireless transport to the destination UE 10.

FIG. 8A illustrates exemplary steps for creating/invoking RLSP in the uplink, and substantially mirrors the steps shown and described for FIG. 7 except that the packet is created in the UE 10 and sent to the BS 12 on the UL rather than the other way around for the DL of FIG. 7. Apart from the mirroring, differences between FIGS. 7 and 8A include the following. At step 8A03, the UE 10 sends to the BS 12 a RLSP creation request message 502, which is responded at step 8A06 with the RLSP creation message 402; there is no RLSP confirm message 404 as in FIG. 7. In other respects, FIG. 8A is a mirror image of FIG. 7.

FIG. 8B illustrates an embodiment for UL RLSP creation and/or invoking thereof that differs from FIG. 8A in the following respects, shown in FIG. 8B by bolded balloons, wherein the diffserv field (DSCP) is not indicated in the subject packet. At step 8B01.2, the source and destination IDs and ports may be present but there is no indication of diffserv. The TFID 208 may then be approved in the BS 12 without a diffserv specified at step 8B09b, and/or the TFID approval at step 8B10.b for the BS 12's IPCS-u 206′-B may decide a diffserv option (DSCP value) or add a DSCP to the header of the packet during decompression of that header. After that packet then, the decided or added DSCP will apply for the remainder of that flow, unless explicitly changed.

As will be appreciated, the bulk of FIGS. 7, 8A and 8B consider creating a new RLSP. FIG. 9 illustrates in a simpler view some of the same substance shown in FIGS. 7-8A, but without the creation of an RLSP and where a pre-configured or default RLSP that is already stored locally in the UE 10 and BS 12 is invoked for a flow. In FIG. 9, the UE 10 initiates the first packet for the flow to be established with the pre-existing RLSP. The UE 10's IPCS 206-U (including both IPCS-c 206-U and IPCS-u 206′-U) requests of the UE 10's RRC 202-U to establish quality parameters for a TFID 208 at 66, which the RRC 202-U creates at 68 by choosing an appropriate (previously stored) RLSP and its identifier RLSP-id. The MAC layer 210-U then associates the TFID 208 with a LCID 224 and confirms 74 to the RRC 202-U with the LCID 224, which is then given 76 to the IPCS 206-U. A packet (data) is sent 78 to the MAC layer 210-U, which sends it over the physical channel(s) 80 to the BS 12 using the TFID 208 and LCID 224 associated in the UE 10 with the chosen RLSP. The BS 12 MAC layer 210-B receives the packet, looks up the RLSP it has stored in its memory 82 from its id given in the packet header, and sends the packet to its IPCS 206-B. The RRC 202-B of the BS 12 is used to map 84 the RLSP-id in the header to the RLSP so that the quality parameters and diffserv code can be met for that packet as it is forwarded.

As was noted, there are three types of RLSPs. Default radio link service profiles may be specified in a standard for different logical channel types. Pre-configured RLSP are defined locally. Any number of pre-configured RLSPs may exist, but they all have a unique reserved RLSP identity. The pre-configuration can occur either in the subscription phase (e.g. SIM-based pre-configuration) or during the initial access. Alternatively, a few pre-configured RLSP profiles could be globally defined and written to the standard specifications, if considered practical. A specific RRC procedure is used to invoke a given pre-configured RLSP at the RRC peer entity.

The customized RLSP is defined locally at the originating entity (UE 10 or BS 12) and its creation is communicated with peer to peer RRC signaling as detailed above. The RADIO LINK SERVICE PROFILE CREATION message 402 contains full description of the parameters of the customized RLSP. It is possible in some embodiments to assign a single radio link service profile to more than one “IP traffic flows” consequently, i.e. a new assignment is invoked after the previous assignment is terminated. It is also possible to assign a single radio link service profile to more than one flow, for flows at different radio links (i.e. different UE 10 served by the BS 12).

If a suitable radio link service profile is available, it can be used by tagging the packets with the associated identifier. Otherwise a customized radio link service profile needs to be created by RRC layers as shown above. A number of radio link service profiles can be created to a UE at the same time. At creation, the RRC layer performs admission control and selects parameters for the radio link service profile (Layer 2), based on information from upper layers. RRC configures Layer 1 and MAC for the radio link service profile. Even when a customized radio link service profile needs to be configured for an IP flow, any packets belonging to that flow that arrive while the customized radio link service profile is created, a specific default/pre-configured radio link service profile can be tentatively used to determine the processing of the packets at radio link layer.

Advantages that are realized by the use of the exemplary embodiments of the invention described in the incorporated application are several, and include the provision of a simple technique to represent IP flows by local radio link radio parameters, the use of RLSP that can be quickly and simply created, assigned and invoked, and that can be readily modified without IP layer involvement. Further, the use of the RLSP eliminates the need for the conventional radio bearers, and the disadvantages inherent in the use of the radio bearers.

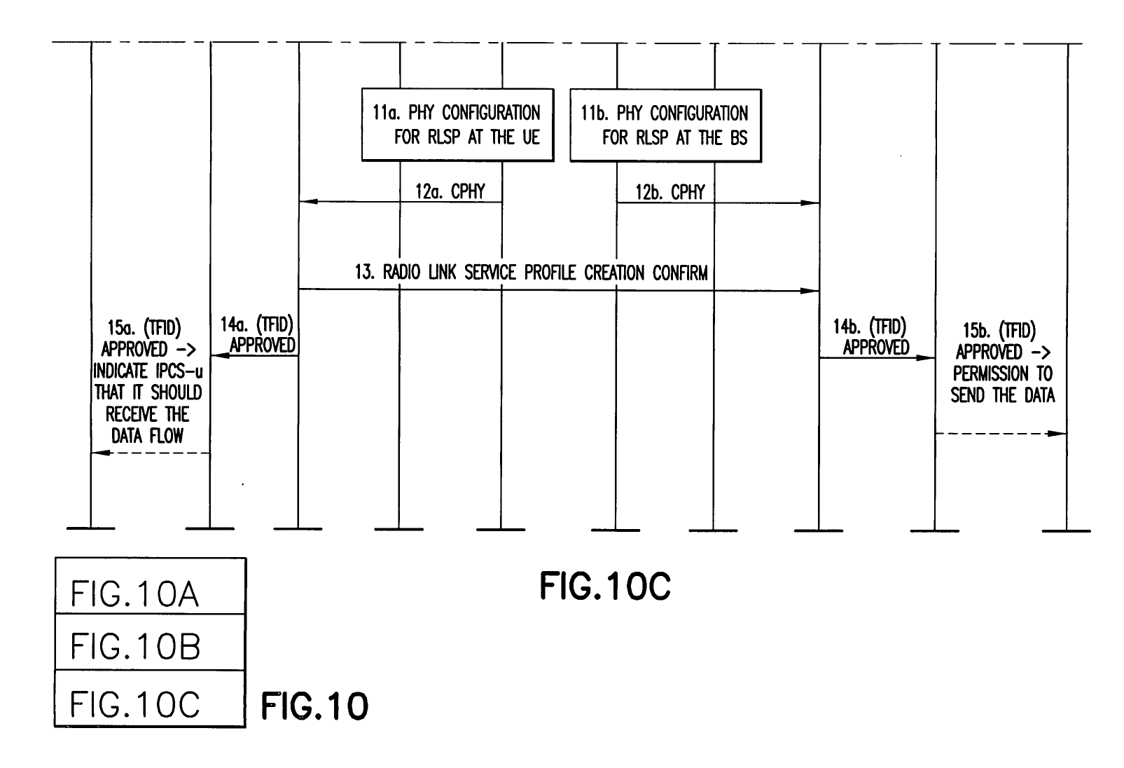

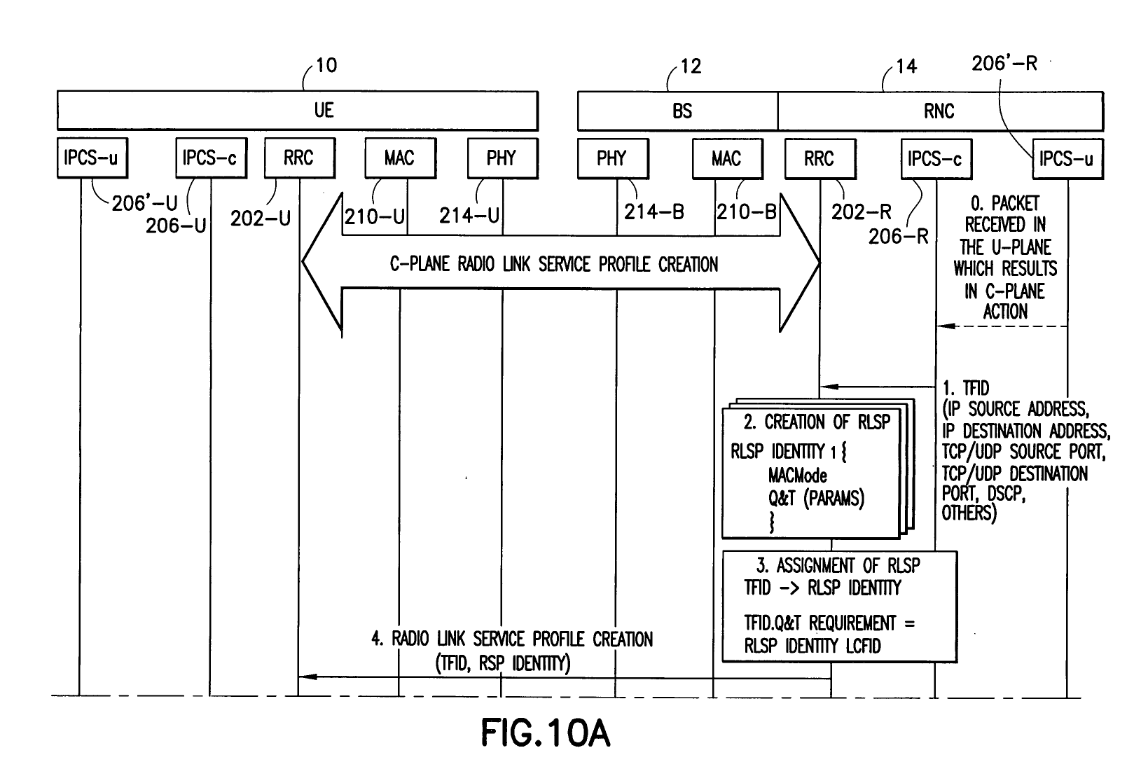

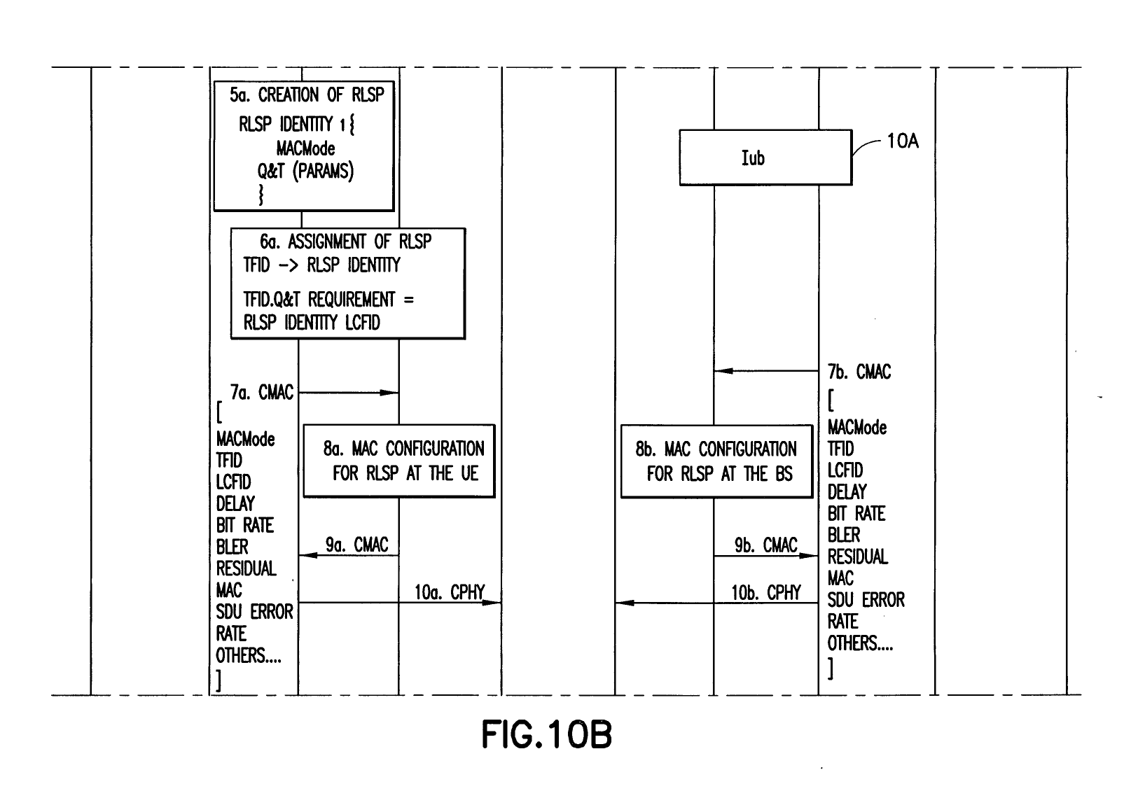

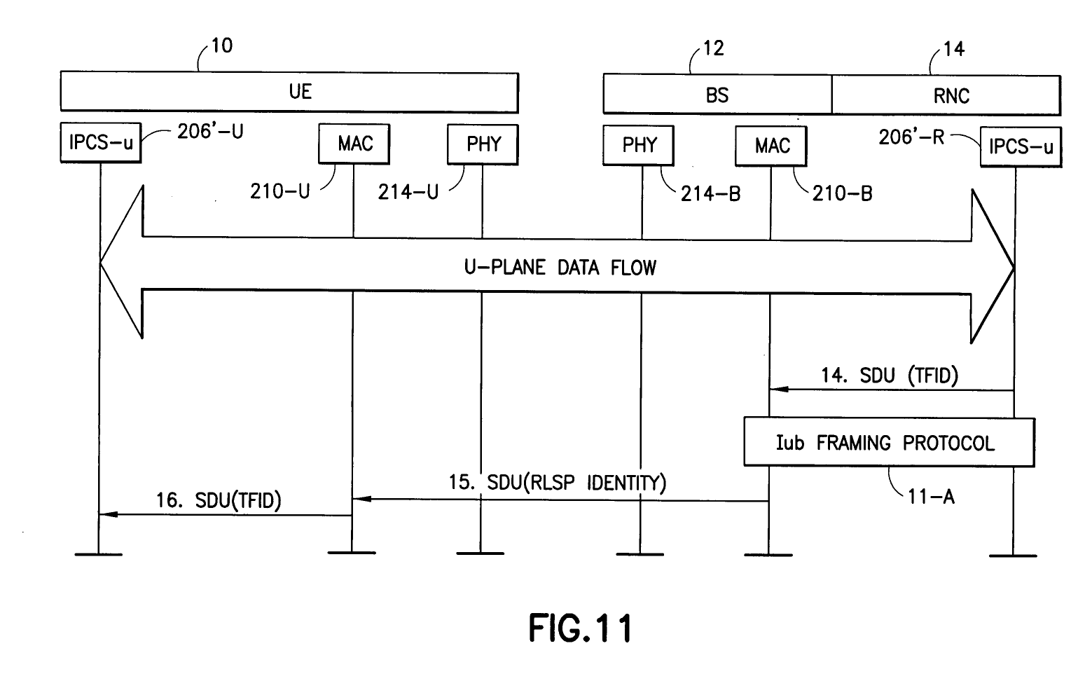

It should be appreciated that is a network architecture (e.g., GERAN/UTRAN) where IP traffic is conveyed with the presence of RNCs the invention may be split between the BS 12 and the RNC 14 processing nodes as shown in FIGS. 10 and 11. Here the notation of the IP traffic flows, the creation and assignment of the RLSP are done in the RNC 14. In this split the RRC protocol in the RNC 14 configures the MAC and PHY in the BS 12 by the created RLSP, or at least invokes a default or a predefined RLSP. As seen in FIGS. 10-11, communications between the RNC 14 and the BS 12 is over the lub interface 10-A, and generally used the lub framing protocol 11-A. In other respects, FIGS. 10-11 mirror FIGS. 3A-3B respectively, except that the RRC 206-R and IPCS 206-R, 206′-R on the network side lie in the RNC 14 rather than in the BS 12 (where the suffix —R indicates RNC 14).

Based on the foregoing it should be apparent that the exemplary embodiments of the invention described in the incorporated application provide a method, an apparatus and a computer program product to uniquely assign an IP flow to a single Radio Link Service Profile, where if the IP flow is defined to support differentiated services, then each such differentiation of the IP flow is assigned to a unique logical channel flow of the assigned Radio Link Service Profile. The Radio Link Service Profile is defined for an upper layer flow and contains a unique profile identity per user equipment with a set of quality and transport parameters that are to be satisfied over MAC-u SAP peer entities. The use of the Radio Link Service Profile enables the elimination of radio bearers to convey IP traffic.

Turning now to a description of the exemplary embodiments of this invention, a solution is provided to enable flexible FlowID management for the MAC layer. The exemplary embodiments of this invention support the introduction and usage of the above-described RLSP as applied to cellular and wireless communication systems, which operate fully in the packet-switched domain without requiring dedicated radio bearers.

In the exemplary embodiments of this invention one assumption is that a FlowID is sent with each packet in the MAC header.

The exemplary embodiments of this invention cover the following (note that FlowID is referred to as the LCID in 3.9G MAC v 1.0.0):

All FlowIDs are classified into “default FlowIDs” and “non-default FlowIDs”. Their respective ranges in the FlowID value range are pre-configured.

Each default FlowID has a static association to a certain service profile. This is pre-configured to both the BS 12 and UE 10, and therefore no RRC signal is needed to set up/reconfigure the associated service profile. Note that since each default FlowID and association to each default service profile is pre-configured to the receiver in advance, the receiver can know the service profile just by checking the FlowID of the packet, without peer-to-peer signaling.

Before the peer-to-peer RRC signaling for setting up the service profile, a non-default FlowID is referred to as an “unregistered FlowID”. An association of “unregistered FlowIDs” to a certain default service profile is pre-configured to both BS 12 and the UE 10. However, a distinction from the default FlowID case is that the service profile can be reconfigured later by using RRC signaling. Note that since the range of unregistered FlowIDs and their association to the default service profile is pre-configured to the receiver in advance, the receiver can know the service profile by checking the FlowID of the packet, without peer-to-peer signaling.

In compliance with the exemplary embodiments of the invention described in the incorporated application, the configuration of the FlowID can encompass, for example, the creation of a new service profile or an assignment of an already existing service profile to the FlowID. The default case is that a new service profile is created, and further changes have no impact on other FlowIDs. However, the exemplary embodiments of this invention do not restrict implementations where a service profile may be associated with multiple FlowIDs for causing a configuration change to impact all associated flows.

After the peer-to-peer RRC signaling for setting up the service profile, a non-default FlowID is referred to as a “registered FlowID”. For a registered FlowID, the association to a service profile is preferably accomplished through the use of peer-to-peer signaling. Since the association is established by the explicit peer-to-peer signaling, the receiver has knowledge of the associated service profile.

The actual values of default FlowIDs and the range of non-default FlowIDs are pre-configured to UE 10 and the BS 12. The pre-configuration may be hard-coded, broadcast, or subscription/SIM-based, as non-limiting examples. The exemplary embodiments of this invention include any type of pre-configuration, and in any type of pre-configuration the benefit of the unregistered FlowIDs can be obtained.

This invention can be applied to both the DL and UL, although in practice its use may be preferred on the DL.

By using the “unregistered FlowID” the service profile reconfiguration may be supported without loss of the advantage of the default service profile provided in accordance with the invention described in the incorporated application. Although the above list describes structure of FlowID concept considered in this invention, a short summary of the FlowID concept is as follows:
there is a fixed partition of the FlowID space into default and registered/unregistered FlowIDs;
unregistered FlowIDs are handled differently from the default FlowIDs in the receiver (because different default service profiles are associated to default FlowIDs and unregistered FlowIDs in advance);
data can be transmitted before the service profile configuration by using the unregistered FlowID, even if the RLSP for the corresponding IP flow is not the default one; and
the service profile can be reconfigured for both unregistered and registered FlowIDs.

With regard to the mechanism for detecting and defining flows, it may be assumed that the upper layer (IPCS) can inform RRC, and pass the IP packets as a flow to the MAC sub-layer. However, all associations of functions to protocol layers are abstractions made for modeling the functionality, and do not directly impact or restrict the various embodiments of the invention described herein.

With regard now to a specific implementation, it is first noted that RLSP is a profile containing QoS attributes of a flow, and that three types of RLSPs are considered.

Default RLSP: Several default RLSPs are considered. (e.g., one for DTCH and two for DCCH). No RRC signaling is required.

Preconfigured RLSP: RLSP parameters and an association to RLSP identity are preconfigured in the RRC. Only the RLSP identity is signaled via the RRC so as to invoke it.

Customized RLSP: RLSP parameters and the association to the RLSP identity are negotiated by the RRC. RRC signaling is used to create/reconfigure the customized RLSP.

With specific regard now to an implementation of the exemplary embodiments of this invention, there is provided a definition of LCID (FlowID) and how it is managed.

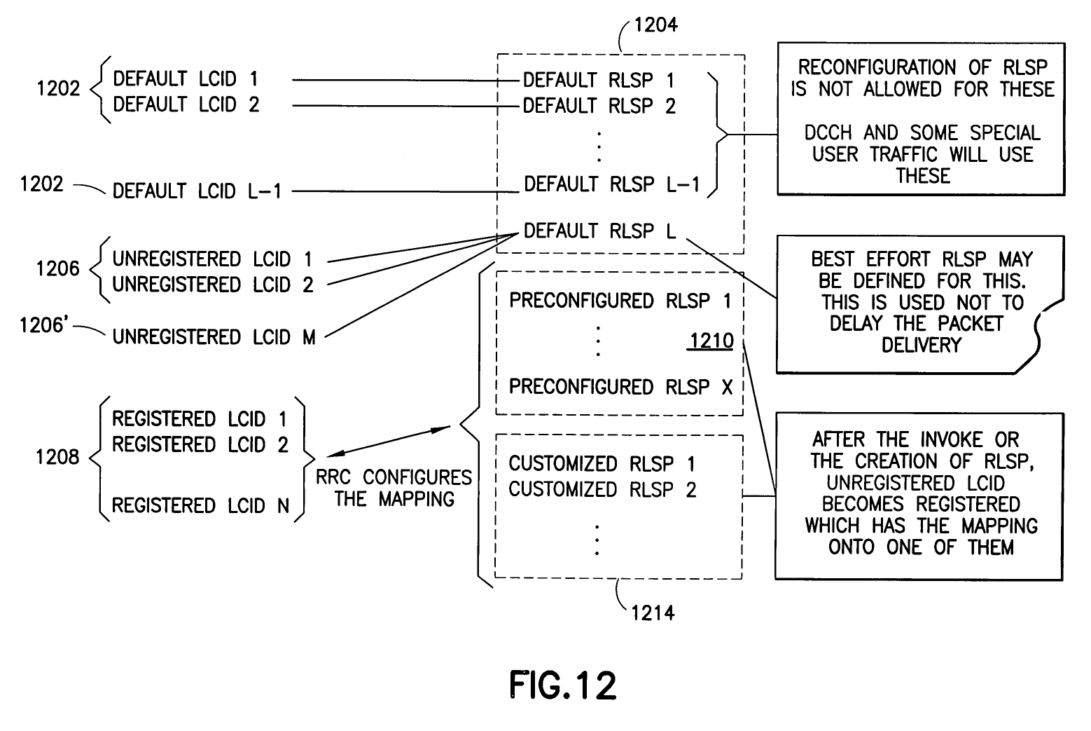

As was noted above, in accordance with the exemplary embodiments of this invention there are three types of LCIDs that are defined to support all types of RLSP, and their dynamic reconfiguration. Note that the three types of LCIDs and three types of RLSPs need not correspond to each other one-to-one. Reference may also be had to FIG. 12.

Default LCID: Every default LCID 1202 has one default RLSP 1204. This mapping is generated in both the UE 10 and the BS 12 when the default RLSP is generated in the system, and cannot be reconfigured during the session. This may be configured as a system setting if desired. Therefore, the default LCID is preferably used for the flows which do not require any reconfiguration of the RLSP. For the control channels (e.g. DCCH 218): the required RLSPs are expected to be constant. For the DTCH 220, and if there are traffic types which does not require any RLSP reconfiguration, the default LCID 1202 and default RLSP 1204 can be defined.

Unregistered LCID: All LCIDs, except for default LCIDs, are initially an unregistered LCID 1206. All unregistered LCIDs 1206 are mapped onto the same default RLSP 1204 that determines their processing at the UE 10 (or, more generally, at the receiver). In order to transfer packets without the RLSP invocation/creation latency, packets in a new flow may be transferred with a unique unregistered LCID 1206 until the RLSP invocation/creation signaling finishes.

It can be noted that the RLSP also determines the processing at the transmitter (e.g., QoS management). However, what is important to notice is that the RLSP can be used at the receiver without any signaling, as the LCID and RLID have a default mapping.

After the RRC signaling (creation or invocation of RLSP) and MAC configuration, the unregistered LCID 1206 becomes the registered LCID 1208 (with no change of LCID value).

There is only one default RLSP without a correspondent default LCID 1202. This particular default RLSP is for unregistered LCIDs 1206. (This default RLSP may be considered to be somewhat equivalent to best-effort service.)

In an alternative embodiment the LCID number space may be partitioned to more than one range of unregistered LCIDs 1206, 106′, with each one having a different default RLSP (mapping shown in FIG. 12 is only to a single default RLSP), if instant initiation of other kinds of best-effort traffic is desired. For example, LCIDs 5-10 are for default best-effort, LCIDs 11-14 are for real-time conversational speech, LCIDs 15-19 are for interactive communications, and so forth.

In order to prevent the use of an excessive number of unregistered LCIDs 1206, it may be desired to impose a maximum limit. For example, one may define a maximum number of unregistered LCIDs 1206, and/or one may define a maximum lifetime of unregistered LCIDs 1206.

Registered LCID: After a RLSP is invoked or created via RRC signaling, and the MAC is configured according to the new RLSP, the unregistered LCID 1206 becomes a registered LCID 1208 on both the UE 10 and BS 12 sides. Further reconfiguration via RRC signaling is also possible.

Each registered LCID 1208 has one pre-configured 1210 or customized 1212 RLSP. If desired it is also within the scope of the exemplary embodiments of this invention to configure the default RLSP 1204 to registered LCIDs 1208. The RLSP can be reconfigured any time.

The use of the exemplary embodiments of this invention provides a number of advantages. For example, all of the advantages of the radio link service profile can be supported (e.g., the RLSP can be assigned, invoked and created quickly, and the QoS can be configured simply without the use of hierarchical bearers). Further, without the use of signaling, the receiver (e.g., the UE 10) can have knowledge of the service profile. By the use of RRC signaling the service profile reconfiguration can be accomplished without changing the FlowID (LCID). Further, the RLSP can be easily reconfigured without requiring packet transfer between queues in the MAC layer. In addition, the MAC implementation becomes simpler.

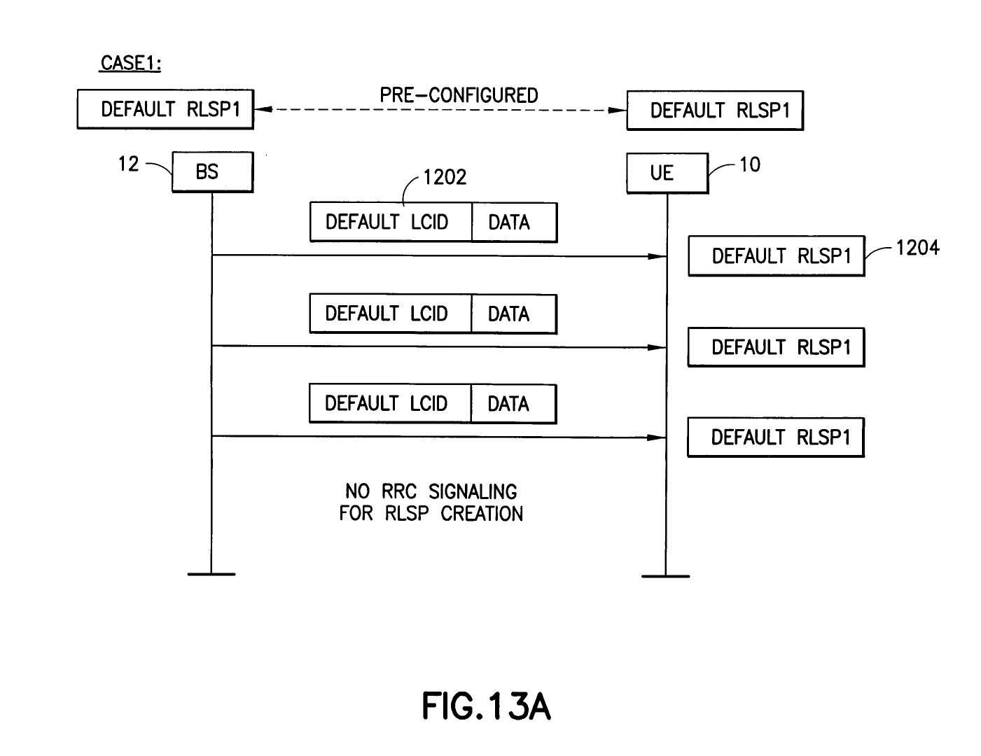

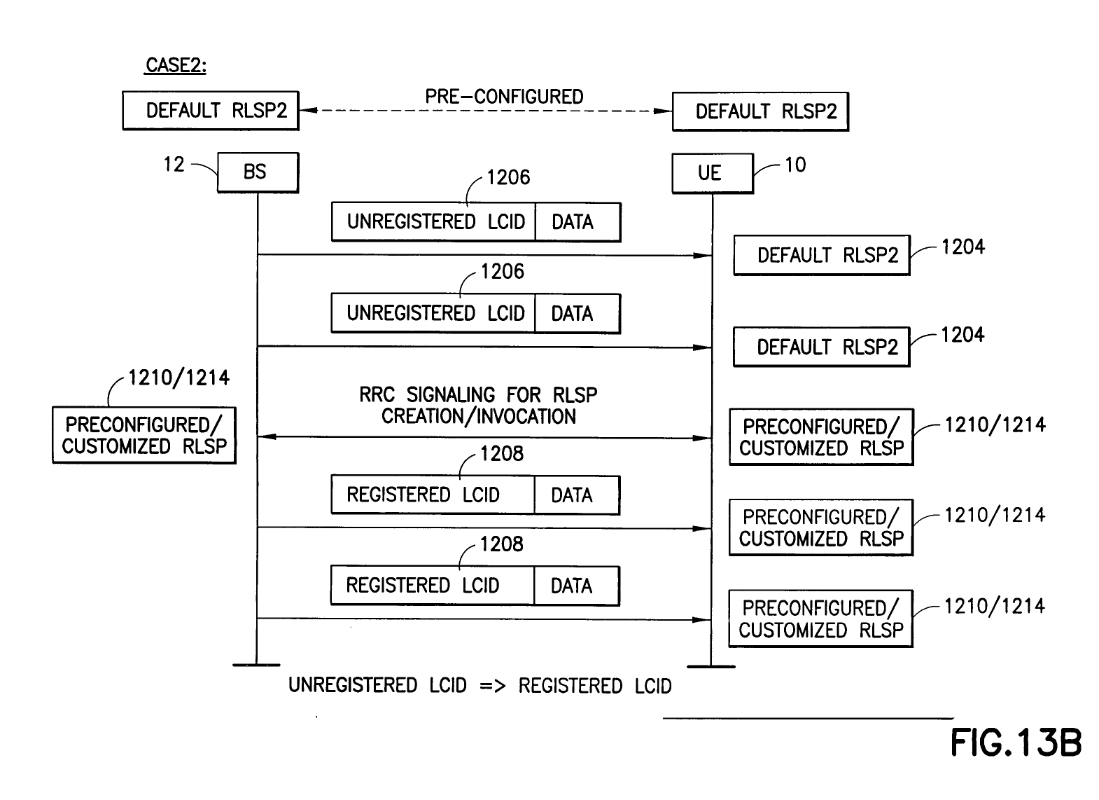

Reference is now made to FIGS. 13A and 13B for showing examples that are useful for explaining certain advantages of the exemplary embodiments of this invention.

In case 1 (FIG. 13A), the “default RLSP1” 1204 is used from the beginning to the end of the session, and there is no need to reconfigure the RLSP. This case is very straightforward, as use of the default LCID 1202 and the preconfigured association is sufficient.

In case 2 (FIG. 13B), the session requires explicit RLSP creation signaling in order to use the “pre-configured RLSP” 1210 or “customized RLSP” 1214. In this case, the use of “unregistered LCID” 1206 brings about an advantage. More specifically, the unregistered LCID 1206 has a pre-configured association to the “default RLSP2” 1204 before the RRC peer-to-peer signaling occurs, and the registered LCID 1208, which is the same as the unregistered LCID 1206 (e.g., the identifier does not change in converting the LCID from unregistered to registered), has a newly-configured association to the “pre-configured/customized RLSP” 1210/1214 after the peer-to-peer RRC signaling. This aspect of the invention supports dynamic RLSP reconfiguration without requiring additional complexity.

To summarize the foregoing, the RLSP may be considered as a profile containing QoS attributes. Three types of RLSPs may be considered, the default RLSP 1204, the preconfigured RLSP 1210, and the customized RLSP 1214.

With regard to the Logical Channel Flow ID (LCID) in the MAC sub-layer, the LCID is attached to each “logical channel flow”, where the logical channel flow is identified by the IPCS (upper layer) based on, for example, the IP header information. The MAC prepares a scheduling buffer for each logical channel flow (one scheduling buffer for one LCID). From the scheduling viewpoint, the LCID should not be changed on the fly, since if the LCID is dynamically changed the packets in its buffer need to be moved. This type of processing is very inefficient. The RRC configures the RLSP to each LCID. For a dynamic QoS attribute update, the association of the RLSP to the LCID may be changed without changing the LCID.

With regard now to LCID definitions in the MAC sub-layer, and in accordance with the exemplary aspects of this invention, to support the RLSP concept the 3.9G MAC sub-layer defines three types of LCIDs.

Default LCID: The Default LCID 1202 and Default RLSP 1204 have a one-to-one default mapping. For the control channel (e.g. DCCH 218) the required RLSPs may be constant, while for the DTCH 220, and if there are traffic types which do not require any RLSP reconfiguration, the default LCID 1202 and default RLSP 1204 can be defined.

Unregistered LCID: LCIDs except the default LCIDs 1202 are each initially an unregistered LCID 1206. After RRC signaling (creation or invocation of RLSP) and MAC configuration, the unregistered LCID 1206 becomes the registered LCID 1208 (with no change of the ID itself). In an embodiment, there is only one default RLSP 1204 without a correspondent default LCID 1202 (i.e., one for all unregistered LCID). This default RLSP 1204 is similar to best-effort service. In another embodiment, there may be different default RLSPs 1204 corresponding to different unregistered LCIDs 1206, 106′ to account for different types of traffic/quality (e.g., best effort, real time conversation), as noted above.

Registered LCID: Each registered LCID 1208 has one RLSP (preconfigured 1210 or custom 1214). The RLSP can be reconfigured any time.

With regard now to several implementation examples, the following may be considered.
Default LCID for DCCH: All control signals are sent by using default LCID 1202 with the QoS level defined by default RLSP.
Default LCID for DTCH: For traffic such as VoIP or SMS, the default LCID 1202 may be prepared with the default RLSP 1204 for reducing the QoS set up latency.
Unregistered LCID for DTCH: For small amounts of data, such as SMS, the unregistered LCID 1206 with default RLSP 1204 may be used for the entire session. The RLSP may eventually need to be reconfigured for the unregistered LCFD 1206 (which would then change the unregistered LCID 1206 to a registered LCID 1208 with RRC signaling to reconfigure the RLSP).
Unregistered LCID and registered LCID for DTCH: For this case, several packets may be sent first via an unregistered LCID 1206 to reduce the latency, and RRC signaling for invoking or creating a RLSP may be sent via the default LCID 1206 at the same time.

After RRC signaling, the unregistered LCID 1206 is configured with the RLSP. (it becomes the registered LCID without any change of the LCID value.)

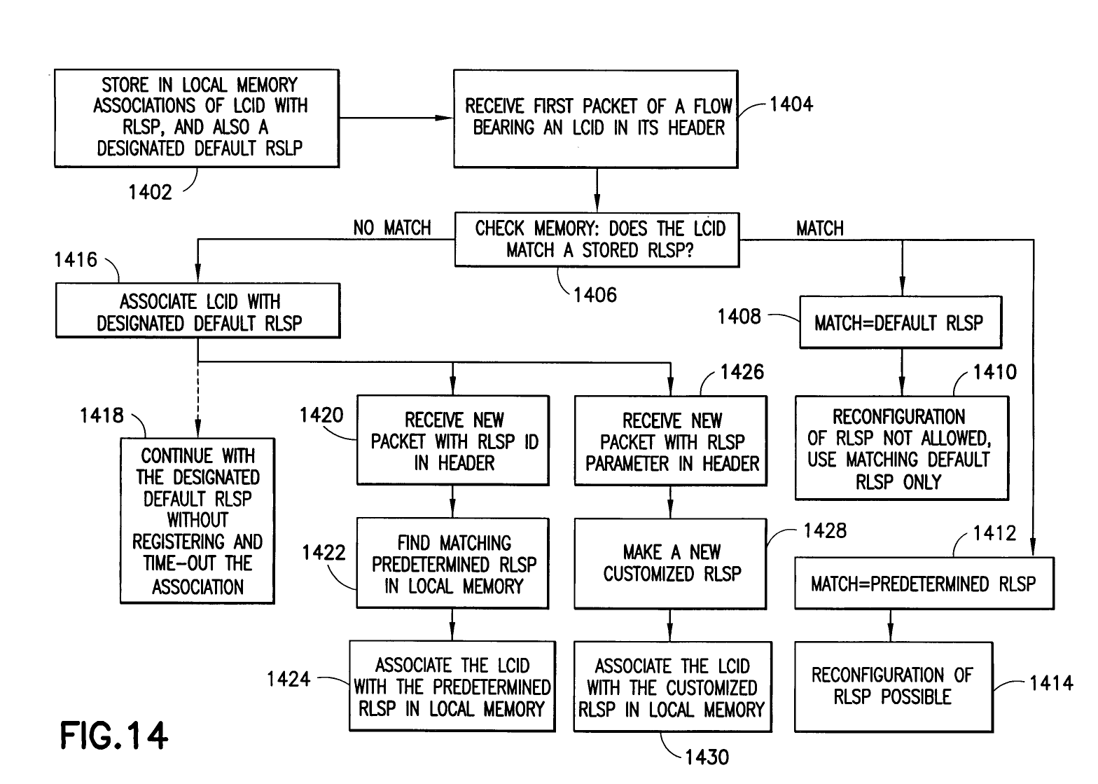

Embodiments of the invention are summarized in the flow diagram of FIG. 14, which may be executed by either the UE 10 or the BS 12, depending on the direction of the flow. At step 1402, an association of LCID with RLSP is stored in the local memory (in both the UE 10 and the BS 12). This initial storage associates one LCID with one RLSP, though any particular RLSP may be matched to more than one LCID. These LCIDs are the predetermined, previously customized, and default RLSPs as detailed above. There is also stored a designated default RLSP, which may be associated with another LCID but which is pre-designated as being the designated default RLSP. At step 1404, a first packet of a new flow is received that bears a specific LCID in its header. At step 1406, the receiving entity (UE 10 or BS 12) checks its local memory to see if there is a pre-existing match between the LCID of the first packet and an RLSP.

If there is a match between that specific LCID at step 1408 to a default RLSP, then the flow is handled in the MAC layer in accordance with that matching default RLSP. Preferably, reconfiguring of that matching default RLSP is not allowed at step 1410, and the entire flow bearing that LCID is handled using that default RLSP. If instead there is a match with a predetermined RLSP at step 1412 (which may have at one time been a customized RLSP), then reconfiguration is possible and at step 1414 the flow is handled in the MAC layer according to the predetermined or reconfigured RLSP.

If instead there is no match in the local memory between the LCID in the first packet header and one of the RLSPs in storage, then the receiving entity associates the LCID of the first packet with the designated default RLSP at step 1418. This represents the instance of an unregistered LCID; the receiving entity has not record in its local storage, prior to receiving that first packet, of an RLSP for that particular LCID. Note that this designated default RLSP need not be an explicit set of parameters; a best effort services may represent the designated default RLSP as detailed above, where the specific parameters for best effort depend on current traffic and channel conditions. Further, the designated default RLSP may be associated with one or more other LCIDs (since an RLSP may be associated with one or more LCIDs though each LCID is associated with only one RLSP). The subject LCID from the first packet header is unregistered because there is no pre-existing association in the local memory of that LCID to a particular RLSP. Three options then exist when an unregistered LCID is received and matched to the designated default RLSP.

Step 1418 represents a special embodiment where the association of the specific unregistered LCID with the designated default RLSP “times out”, wherein the association (but not the RLSP) is erased from the local memory after no packets bearing the LCID are sent or received over a predetermined period of time. That predetermined period of time may also be stored in a local memory, and erasing the association from the local memory may be automatic based on the lack of traffic over that time period. Absent this special embodiment, the association is deleted once the flow terminates.

At step 1420, a second packet is received that bears a RLSP identifier along with the LCID). The second packet (at steps 1420 or 1426) may be any packet subsequent to the first packet (of step 1404) bearing the same LCID. In this instance, the receiving entity checks its local memory for the one RLSP corresponding to that RLSP identifier at step 1422, and once found, then automatically associates at step 1424 the RLSP that matches the RLSP identifier with the LCID. In this instance, the previously stored RLSP is now associated with the new LCID merely by signaling the RLSP identifier so as to invoke an RLSP stored in the local memory, rather than signaling the entire set of packet transport parameters. After step 1418, the designated default RLSP remains unchanged from step 1402.

At step 1426, the second packet is received that carries one or more specific packet transport parameters, preferably in its header. This represents RRC signaling, and the entire set of parameters or only one/some of them may be sent. Immediately prior to receipt of that second packet, the receiving entity is using the designated default RLSP for the LCID given in the first packet (identical to the LCID in the second packet). The receiving entity reads the packet transport parameters from the second packet, replaces those corresponding parameters of the set given by the designated default RLSP with those received in the second packet in order (thereby forming a customized RLSP) at step 1428, and associates the LCID in its local memory with the newly formed customized RLSP at step 1430. Further packets in the flow are handled using the customized RLSP, and the designated default RLSP remains unchanged from step 1402.

Further changes to the governing RLSP (after any of steps 1414, 1424 or 1430) for the LCID may be made by following steps 1420-1422-1424 or steps 1426-1428-1430 in packets subsequent to the second packet, all without changing the LCID.

The inventors have realized that the capacity of the BS 12 and its capabilities should be scaled so as to accommodate the number of unregistered logical channels LCIDs used by a potentially large number of active mobile user equipment (UE 10) in a given cell. In the uplink direction, the reception of each logical channel, in practice, utilizes a certain amount of dedicated network resources, in terms of not only radio resources but also hardware and software resources of network elements. This amount of resources may then need to be reserved in advance for each logical channel, due to limited network capacity and capability.

In this case it may be that the required network resource/capability could potentially exceed the available BS 12 capacity and capability if active user equipment (UE 10) are permitted to simultaneously use a number of unregistered logical channels. This scenario is of particular concern to the BS 12 in the uplink. It may thus be appreciated that to employ unregistered logical channels in a robust and effective manner, it would be desirable to provide a simple admission control that determines how unregistered logical channels should be used. The exemplary embodiments of this aspect of the invention provide a simple control signaling technique and mechanism in which constraint information related to the use of unregistered logical channels is determined by the network side and sent to the UE 10 during, as non-limiting examples, an initial access phase or during cell-reselection.

In accordance with exemplary embodiments of this aspect of the invention, an Unregistered Logical Channel control information element (IE) is introduced into at least one control-signaling message sent from the network via the BS 12. The Unregistered Logical Channel control IE may be sent, as a non-limiting example, as part of a Radio Resource Control (RRC) protocol. The Unregistered Logical Channel control IE includes a maximum allowed number of simultaneous unregistered logical channels for an active UE 10, and may also include other constraints, such as maximum life-time of unregistered logical channels specified for a certain range of identifier space. This information can be used to define a deadline for forcing an unregistered logical channel to become a registered one, or to be deleted, as two non-limiting examples. The Unregistered Logical Channel control IE may be sent (and updated) to the UE 10 through broadcast system information. In this case the information conveyed by the Unregistered Logical Channel control IE is valid for all active UEs 10 in the cell in which the IE is sent. The value of the constraint(s) conveyed by the Unregistered Logical Channel control IE may be determined and updated based on overall user and network performance characteristics (that is, it may be semi-static and controlled over a long term). The Unregistered Logical Channel control IE may also be sent and updated on a per UE 10 basis through cell association (or radio connection) establishment during the initial access phase and/or serving-cell change and, in this case, the control information is valid to the particular UE 10 to which the Unregistered Logical Channel control IE is sent. In this case the value of the constraint(s) may be determined based on, as non-limiting examples, the current available resources of the network, the capability of the given UE 10, and/or a subscriber QoS of the given UE 10. In this case the constraint(s) may be considered to dynamic or quasi-dynamic in nature.

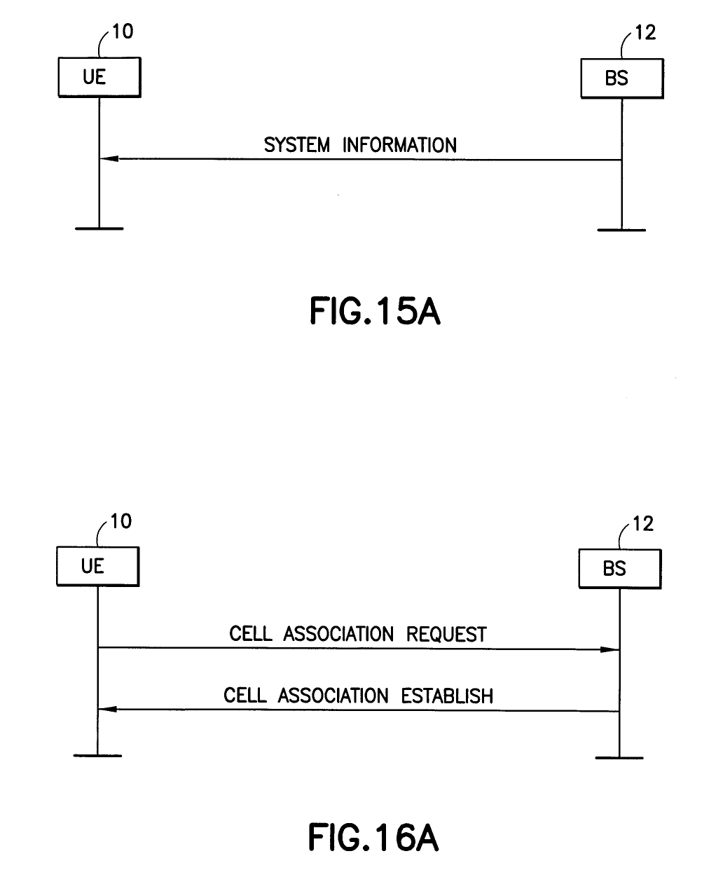

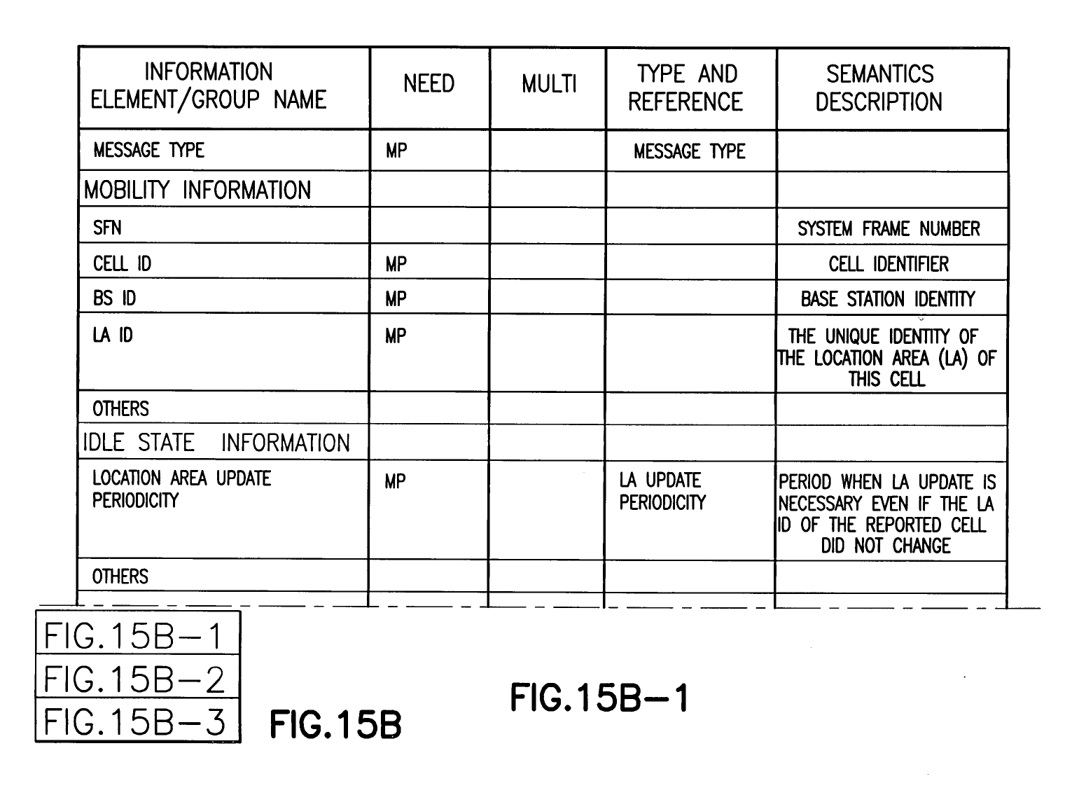

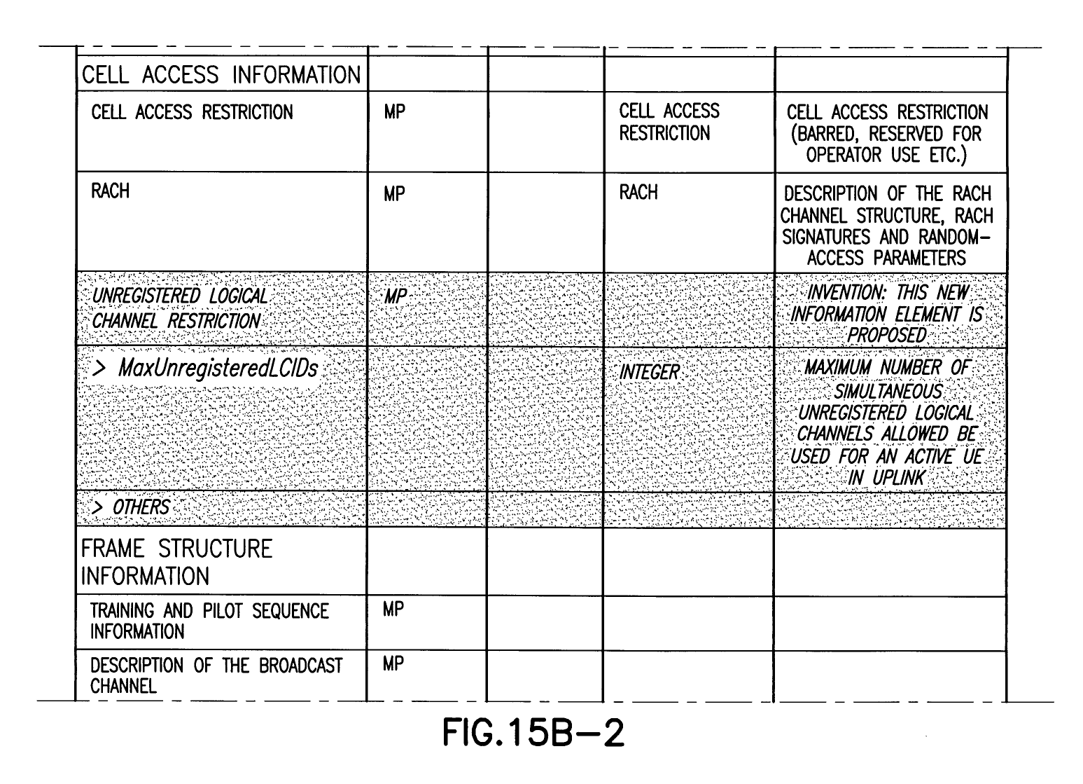

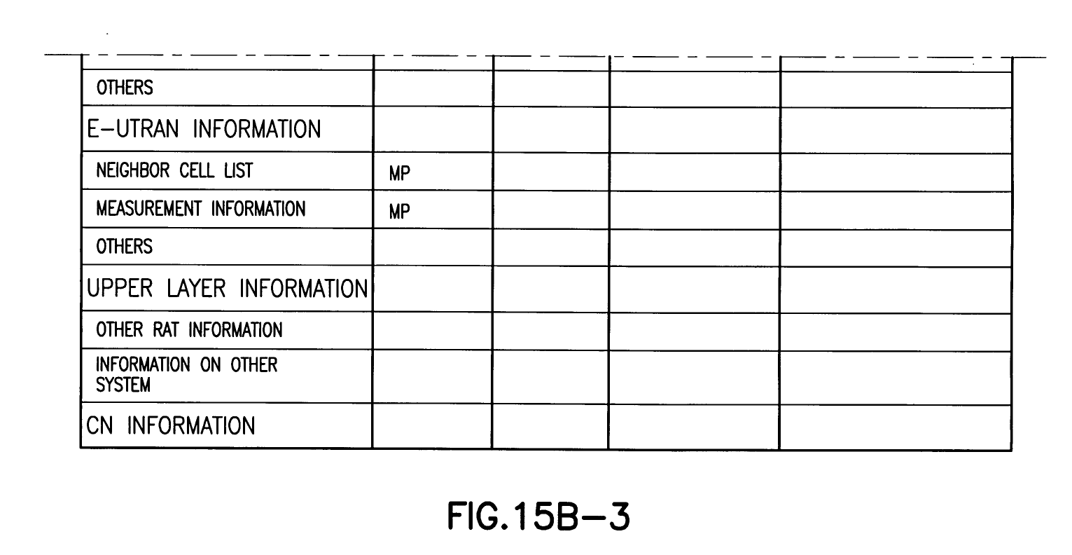

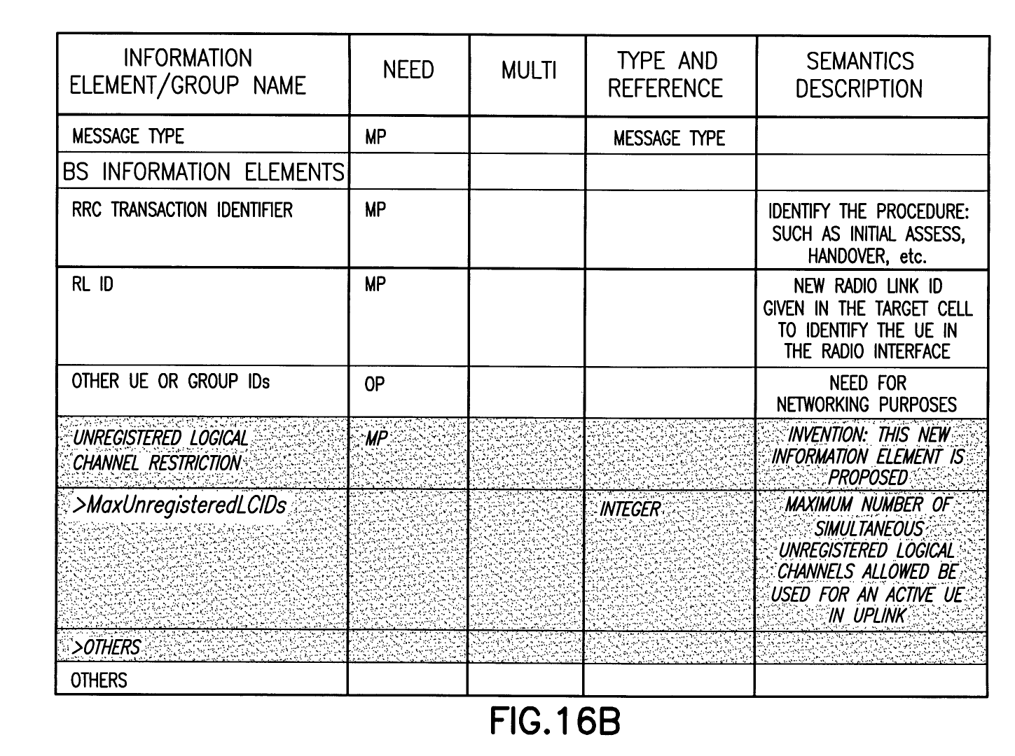

In the implementation of this aspect of the invention, flexibility is provided in the choice of constraint declaration and the algorithm or procedure used to set the value of constraint(s). For example, RRC signaling procedures which can be used to implement the control mechanism as described above are illustrated in FIG. 15A (all-UE in cell system information broadcast case) and FIG. 16A (per-UE cell establishment case). The content of a signaling message that includes the Unregistered Logical Channel control IE, referred to as an Unregistered Logical Channel Restriction IE, may be defined (as one non-limiting example) as shown below, along with other information relevant to the UE 10. The additional information is shown in FIGS. 15B and 16B respectively for the system information case and the cell establishment case in bold and in italics to distinguish it from the other information.

With regard to the UE 10, if the number of on-going unregistered logical channels is already the maximum allowed number, the RRC (assumed to be implemented at least in part by the program 10C) of the UE 10 should not assign any new unregistered logical channel (identifiers) to newly detected traffic flows. Further, if the lifetime of an existing unregistered logical channel exceeds the specified maximum life-time, the RRC of the UE 10 should request the u-plane of the UE 10 to discard the packets to be delivered on this unregistered logical channel, or alternatively the RRC of the UE 10 may begin peer-to-peer signaling of a radio link service profile invoke with the same default setting so as to make it a registered one.

With regard to the BS 12, and by example, if the BS 12 detects that a UE 10 is using more unregistered logical channels than the allowed maximum, the BS 12 terminates giving the UL resource allocation to the UE 10. In addition, if the BS 12 detects that an unregistered logical channel is used for longer than the specified maximum lifetime, the BS 12 may begin peer-to-peer signaling of the radio link service profile invoke with the same default setting so as to make it the registered one, or, the BS 12 may terminate giving the UL resource allocation to the UE 10.

As can be appreciated, the exemplary embodiments of this aspect of the invention provide a simple signaling control method to ensure a robust and efficient system operation using unregistered logical channels. This does not require any significant changes in existing mechanisms and procedures, nor any significant signaling or processing overhead.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

We claim:

1. A method comprising:
storing in a local memory a series of logical channel identifiers LCIDs each associated with one radio link service profile RLSP, said local memory accessed whenever a LCID Is taken into use for identifying an active logical channel, each RLSP comprising a set of radio link service parameters at least one of which is a quality of service parameter;
after storing, receiving over a wireless logical channel a first data packet bearing a LCID that establishes a flow;
accessing the local memory to determine if an RLSP is associated with the LCID;
for the case where an RLSP is not associated with the LCID in the local memory, associating the LCID with a designated default RLSP; and
processing the first data packet using the designated default RLSP.

2. The method of claim 1, further comprising, after associating the LCID with the designated default RLSP:
exchanging radio resource control RRC signaling with the sender of the first packet to register the LCID to the designated default RLSP; and
storing in the local memory an association of the registered LCID to the designated default RLSP.

3. The method of claim 1, further comprising, after associating the LCID with the designated default RLSP:
receiving a new packet bearing the LCID and a RLSP identifier that is not associated in the local memory with the designated default RLSP, and thereafter;
accessing from the local memory a predetermined RLSP associated with the RLSP identifier;
storing in the local memory an association of the LCID with the predetermined RLSP; and
processing the new packet in a medium access control layer using the predetermined RLSP.

4. The method of claim 1, further comprising, after associating the LCID with the designated default RLSP:
receiving a new packet bearing the LCID and at least one radio link service parameter different than a corresponding parameter of the designated default RLSP, and thereafter;
storing in the local memory a customized RLSP that differs from the default RLSP in the at least one radio link service parameter;
storing in the local memory an association of the LCID with the customized RLSP; and
processing the new packet in a medium access control layer using the customized RLSP.

5. The method of claim 1, wherein the designated default RLSP comprises that set of radio link service parameters that represent best effort services.

6. The method of claim 1, wherein the association between the LCID and the designated default RLSP is automatically removed from the local memory after a predetermined period of time elapses during which no packets bearing the LCID are either sent or received.

7. The method of claim 1, wherein the local memory stores a series of default LCIDs, each default LCID associated with one non-reconfigurable default RLSP, said designated default RLSP not one of the non-reconfigurable default RLSPs.

8. The method of claim 1 executed by a network entity, further comprising:
prior to receiving the first packet, storing a maximum number of unregistered logical channels for uplink use, each logical channel associated with an LCID, and sending a message indicating the maximum number; and
after receiving the first data packet, comparing a number of active unregistered logical uplink channels in use by the sender of the first data packet to the stored maximum number.

9. The method of claim 8, wherein for the case where the number of active unregistered logical channels exceeds the stored maximum number, reducing the number of active unregistered logical channels by registering the LCID.

10. The method of claim 8, wherein the message comprises a broadcast message.

11. The method of claim 8, wherein the message is directed to the sender of the first data packet during initial network access or cell reselection of the sender.

12. The method of claim 8, wherein for the case where the number of active registered logical uplink channels in use by the sender of the first data packet exceeds the stored maximum number, the method further comprising:
terminating at least some uplink resources that are currently allocated to the sender.

13. The method of claim 8, wherein for the case where the number of active registered logical uplink channels in use by the sender of the first data packet exceeds the stored maximum number, the method further comprising:
initiating registration of a new RLSP using the set of radio link service profile parameters of the designated default RLSP and thereafter registering the LCID with the new RLSP.

14. A method for operating a user equipment UE comprising:
storing in a local memory a series of logical channel identifiers LCIDs each associated with one radio link service profile RLSP, said local memory accessed whenever a LCID is taken into use for identifying an active logical channel, each RLSP comprising a set of radio link service parameters at least one of which is a quality of service parameter;
determining from a received message a maximum number of unregistered logical uplink channels;
establishing at least one flow using an unregistered LCID that is not associated in the local memory with an RLSP;
preparing a data packet to be sent on an additional flow using an additional unregistered LCID;
comparing the maximum number to the total number of logical uplink channels in use by the UE on flows using an unregistered LCID;
responsive to the comparing and for the case where the total number exceeds the maximum number, reducing the total number of logical uplink channels in use.

15. The method of claim 14, wherein reducing comprises deleting the data packet without sending it.

16. The method of claim 14, wherein reducing comprises registering the additional unregistered LCID to an RLSP.

17. A program of machine-readable instructions, tangibly embodied on an computer readable memory and executable by a digital data processor, to perform actions directed toward processing a data packet with a set of service parameters, the actions comprising:
storing in a local memory a series of logical channel identifiers LCIDs each associated with one radio link service profile RLSP, said local memory accessed whenever a LCID is taken into use for identifying an active logical channel, each RLSP comprising a set of radio link service parameters at least one of which is a quality of service parameter;
after storing, determining from a first data packet received over a wireless logical channel a LCID that establishes a flow;
accessing the local memory to determine if an RLSP is associated with the LCID;
for the case where an RLSP is not associated with the LCID in the local memory, associating the LCID with a designated default RLSP; and
processing the first data packet using the designated default RLSP.

18. The program of claim 17, the actions further comprising, after associating the LCID with the designated default RLSP:
exchanging radio resource control RRC signaling with the sender of the first packet to register the LCID to the designated default RLSP; and
storing in the local memory an association of the registered LCID to the designated default RLSP.

19. The program of claim 17, the actions further comprising, after associating the LCID with the designated default RLSP:
determining from a new packet, wirelessly received and bearing the LCID, a RLSP identifier that is not associated in the local memory with the designated default RLSP, and thereafter;
accessing from the local memory a predetermined RLSP associated with the RLSP identifier;
storing in the local memory an association of the LCID with the predetermined RLSP; and
processing the new packet in a medium access control layer using the predetermined RLSP.

20. The program of claim 17, the actions further comprising, after associating the LCID with the designated default RLSP:
determining from a new received packet, wirelessly received and bearing the LCID, at least one radio link service parameter different than a corresponding parameter of the designated default RLSP, and thereafter;
storing in the local memory a customized RLSP that differs from the default RLSP in the at least one radio link service parameter;
storing in the local memory an association of the LCID with the customized RLSP; and
processing the new packet in a medium access control layer using the customized RLSP.

21. The program of claim 17, wherein the memory and the processor are disposed in a network node, the actions further comprising:
prior to receiving the first packet, storing a maximum number of unregistered logical channels for uplink use, each logical channel associated with an LCID, and sending a message indicating the maximum number; and
after receiving the first data packet, comparing a number of active unregistered logical uplink channels in use by the sender of the first data packet to the stored maximum number.

22. The program of claim 21, wherein for the case where the number of active unregistered logical channels exceeds the stored maximum number, the actions further comprise reducing the number of active unregistered logical channels by at least one of:
registering the LCID to an RLSP; and
terminating at least some uplink resources that are currently allocated to the sender.

23. A device comprising:
a memory to store a series of logical channel identifiers LCIDs each associated with one radio link service profile RLSP, said memory accessed whenever a LCID is taken into use for identifying an active logical channel, each RLSP comprising a set of radio link service parameters at least one of which is a quality of service parameter;
a transceiver to receive over a wireless logical channel a first data packet bearing a LCID that establishes a flow;
a processor coupled to the memory and the transceiver to:
determine if there is an association in the memory of an RLSP with the LCID;
for the case where an RLSP is not associated with the LCID in the memory, associating the LCID with a designated default RLSP; and
process the first data packet using the designated default RLSP.

24. The device of claim 23, wherein after associating the LCID with the designated default RLSP, the transceiver operates to exchange radio resource control RRC signaling with the sender of the first packet to register the LCID to the designated default RLSP; and
the processor operates to store in the memory an association of the registered LCID to the designated default RLSP.

25. The device of claim 23, wherein, after associating the LCID with the designated default RLSP, the processor operates to:
determine from a new packet, wirelessly received by the transceiver and bearing the LCID, a RLSP identifier that is not associated in the memory with the designated default RLSP, and thereafter;
access from the memory a predetermined RLSP associated with the RLSP identifier;
store in the memory an association of the LCID with the predetermined RLSP; and
processing the new packet in a medium access control layer using the predetermined RLSP.

26. The device of claim 23, wherein after associating the LCID with the designated default RLSP, the processor operates to:
determine from a new packet, wirelessly received by the transceiver and bearing the LCID, at least one radio link service parameter that is different than a corresponding parameter of the designated default RLSP, and thereafter;
store in the memory a customized RLSP that differs from the default RLSP in the at least one radio link service parameter;
store in the memory an association of the LCID with the customized RLSP; and
process the new packet in a medium access control layer using the customized RLSP.

27. The device of claim 23, wherein the device comprises a network element configured such that:
prior to receiving the first packet, the memory stores a maximum number of unregistered logical channels for uplink use, each logical channel associated with an LCID, and sending a message indicating the maximum number; and
after receiving the first data packet, the processor operates to compare a number of active unregistered logical uplink channels in use by the sender of the first data packet to the stored maximum number.

28. The device of claim 23, wherein for the case where the number of active unregistered logical channels exceeds the stored maximum number, the processor operates to reduce the number of active unregistered logical channels by at least one of:
registering the LCID; and
terminating at least some uplink resources that are currently allocated to the sender.

29. A user equipment comprising:
a memory to store a series of logical channel identifiers LCIDs each associated with one radio link service profile RLSP, said memory accessed whenever a LCID is taken into use for identifying an active logical channel, each RLSP comprising a set of radio link service parameters at least one of which is a quality of service parameter;
a transceiver to wirelessly receive a message indicating a maximum number of unregistered logical uplink channels, and to establish at least one flow using an unregistered LCID that is not associated in the local memory with an RLSP;
a processor to prepare a data packet to be sent on an additional flow using an additional unregistered LCID, the processor further to compare the maximum number to the total number of logical uplink channels in use by the UE on flows using an unregistered LCID, an responsive to the comparing and for the case where the total number exceeds the maximum number, the processor operates to reduce the total number of logical uplink channels in use.

30. The device of claim 29, wherein the processor operates to reduce by deleting the data packet without sending it from the transceiver.

31. The device of claim 29, wherein the processor operates to reduce by registering the additional unregistered LCID to an RLSP.

32. An integrated circuit comprising:
circuitry to determine from a first data packet received over a wireless logical channel a LCID that establishes a flow;
circuitry to determine, from a local memory coupled to the integrated circuit that stores a series of logical channel identifiers LCIDs each associated with one radio link service profile RLSP, whether the LCID of the first packet is associated with an RLSP, where the local memory is accessed whenever a LCID is taken into use for identifying an active logical channel, and where each RLSP comprises a set of radio link service parameters at least one of which is a quality of service parameter;
circuitry for associating the LCID with a designated default RLSP for the case where an RLSP is not already associated with the LCID in the local memory; and
circuitry for processing the first data packet using the designated default RLSP.

33. A device comprising:
means for locally storing a series of logical channel identifiers LCIDs each associated with one radio link service profile RLSP, said means for locally storing being accessed whenever a LCID is taken into use for identifying an active logical channel, each RLSP comprising a set of radio link service parameters at least one of which is a quality of service parameter;
means for receiving over a wireless logical channel a first data packet bearing a LCID that establishes a flow;
means for determining, using the means for locally storing, if an RLSP is associated with the LCID;
responsive to the means for determining that an RLSP is not associated with the LCID, means for associating the LCID with a designated default RLSP; and
means for processing the first data packet using the designated default RLSP.

34. The device of claim 33, wherein
the means for locally storing comprises a computer readable memory;
the means for receiving comprises a transceiver;
the means for determining, means for associating, and means for processing comprises a processor coupled to the memory and transceiver.
